(19) United States
(12) Patent Application Publication
(10) Pub. No.: US 2020/0385607 A1
(43) Pub. Date: Dec. 10, 2020

(54) A COMPOSITION COMPRISING METHYLENE MALONATE MONOMER AND POLYMER, THE PREPARATION THEREOF AND USE OF THE SAME IN FLOORING APPLICATIONS

(71) Applicant: BASF SE, Ludwigshafen am Rhein (DE)

(72) Inventors: Lei MENG, Shanghai (CN); Sheng Zhong ZHOU, Shanghai (CN); Stefan HIRSEMANN, Shanghai (CN); Harald ROECKEL, Muenster (DE)

(21) Appl. No.: 16/958,680

(22) PCT Filed: Dec. 18, 2018
(86) PCT No.: PCT/EP2018/085442

§ 371 Date: Jun. 27, 2020

(30) Foreign Application Priority Data
Dec. 27, 2017 (CN) PCT/CN2017/119093

(51) Int. Cl. C09D 167/06; C09D 4/06; C08G 63/54; C08K 3/014; C08K 3/30; C08K 5/095

(52) U.S. Cl. CPC C09D 167/06; C09D 4/06; C08G 63/54; C08K 2003/309; C08K 3/30; C08K 5/095; C08K 3/014

(57) ABSTRACT

The present invention relates to a composition comprising methylene malonate monomer and polymer in construction field. Particularly, the invention relates to a two-component composition comprising at least one methylene malonate monomer (A), at least one polymer (B) and at least one acidic stabilizer (C), and component II comprising at least one alkali accelerator, to the preparation thereof, and to the use of the composition as a coating material, particularly as a flooring coat.

### TECHNICAL FIELD

The present invention relates to a composition comprising methylene malonate monomer and polymer in construction field. Particularly, the invention relates to a two-component composition comprising at least one methylene malonate monomer (A), at least one polymer (B) and at least one acidic stabilizer (C), and component II comprising at least one alkali accelerator, to the preparation thereof, and to the use of the composition as a coating material, particularly as a flooring coat.

### BACKGROUND

Flooring coats are applied onto substrates like wood, concrete, stone etc. to protect the surfaces of the substrates. To achieve that purpose, the flooring coats are required to have good mechanical performance such as tensile strength and abrasion resistance. In certain application situations, for example, plants of chemical industry or food processing, flooring coats are further required to resist acid, alkali as well as other solvents. And sometimes flooring coats are used to patch the crack or exfoliation and therefore it requires a strong adhesion to the existing flooring coats. Moreover, workability is also a significant requirement for flooring coats.

Current flooring coats are mainly based on epoxy, polyurethane, polyacrylate or unsaturated polyester. But each of them have their own disadvantages. Epoxy resin is slow curing at low temperature like 0° C. The monomer of polyurethane i.e. isocyanate is not environmental friendly and moreover, a high humidity environment for its curing tend to cause foaming and blistering of the flooring coats. The monomer of polyacrylate is methacrylate having strong pungent odor and its initiator for polymerization is explosive peroxide. Moreover, the curing of polyacrylate is sensitive to oxygen i.e. oxygen hinders the curing, which tend to make the surface of the flooring coats greasy or tacky.

Therefore, it is still required to provide a flooring coats that is solvent free, chemical resistant, fast curing in a wide range of temperature and humidity and at the same time, having good mechanical performances.

### SUMMARY OF THE PRESENT INVENTION

An object of this invention is to provide a composition which, as a flooring coating material, does not have the above deficiencies in the prior art. Particularly, an object of this invention is to provide a novel composition, wherein the methylene malonate monomer and the polymer thereof are mixed in a specific ratio. Such composition can undergo fast curing with a low amount of alkali accelerator, and can be applied in an extreme condition, such as at a low temperature and a high humidity level, and thus suitable for a flooring application. The resulting cured product is substantially a 100% solid compound with little volatile organic compounds (VOC), and shows excellent performances in terms of tensile strength and mechanical and chemical resistance, especially abrasion resistance, and the like.

Surprisingly, it has been found by the inventor that the above objection can solved by a composition comprising Component I comprising:

(A) at least one of methylene malonate monomer having formula (I)

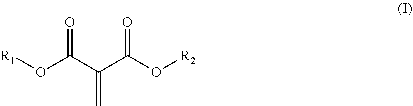

wherein, R₁ and R₂ are in each case independently selected from the group consisting of C1-C30-alkyl, C2-C30-alkenyl, C3-C30-cyclolalkyl, C2-C30-heterocyclyl, C2-C30-heterocyclyl-(C1-C30-alkyl), C6-C30-aryl, C6-C30-aryl-C1-C30-alkyl, C2-C30-heteroaryl, C2-C30-heteroaryl-C1-C30-alkyl, and C1-C30-alkoxy-C1-C30-alkyl, halo-C1-C30-alkyl, halo-C3-C30-cyclolalkyl, each of which radicals is optionally substituted, the heteroatom being selected from N, O and S;

(B) at least one methylene malonate polymer having formula (II):

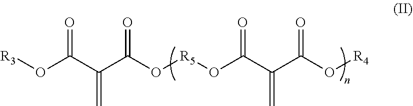

wherein, R₃ and R₄ are, in each case independently selected from the group consisting of C1-C30-alkyl, C2-C30-alkenyl, C3-C30-cyclolalkyl, C2-C30-heterocyclyl, C2-C30-heterocyclyl-C1-C30-alkyl, C6-C30-aryl, C6-C30-aryl-(C1-C30-alkyl), C2-C30-heteroaryl, C2-C30-heteroaryl-C1-C30-alkyl, C1-C30-alkoxy-C1-C30-alkyl, halo-C1-C30-alkyl, and halo-C3-C30-cyclolalkyl, each of which radicals is optionally substituted, the heteroatom being selected from N, O and S;

n is an integer from 1 to 20;

R₅, if n=1 is, or if n>1 are in each case independently, selected from the group consisting of C1-C30-alkylene, C2-C30-alkenylene, C2-C30-alkynylene, C6-C30-arylene, C3-C30-cyclolalkylene, C3-C30-cyclolalkenylene, C3-C30-cyclolalkynylene, C2-C30-heterocyclylene, and C2-C30-heteroarylene, each of which radicals is optionally substituted, the heteroatom being selected from N, O and S, wherein R₅ is optionally interrupted by a radical selected from N, O and S; and

(C) at least one acidic stabilizer;

and Component II comprising at least one alkali accelerator;

wherein, the component (A) is in an amount of from 0 to 40 wt. %, preferably from 5 to 35 wt. % and more preferably from 10 to 30 wt. %, and most preferably 15 to 20 wt. %, in each case based on the total weight of the monomer (A) and the polymer (B);

the acidic stabilizer (C) is in an amount of from 0.1 to 500 ppm, preferably from 0.1 to 300 ppm and more preferably from 0.1 to 200 ppm; and

the component II is in an amount of from 0.01 to 10 wt. %, preferably from 0.05 to 5 wt. % and more preferably from 0.1 to 2 wt. %, in each case based on the total weight of the monomer (A) and the polymer (B).

In a further aspect, the invention relates to a mixture comprising the two-component composition according to the invention.

The two-component composition may be prepared by a process comprising steps of:

(1) mixing the monomer (A), the polymer (B) and the acidic stabilizer (C) to obtain the component I; and

(2) preparing component II.

It has been surprisingly found that the two-component composition according to this invention can be cured even at a low temperature below 0° C. and a high humidity level. The cured coating thus-obtained exhibit both sufficient resistance to water, solvent and abrasion, and high chemical and mechanical strength, and thus are suitable as a flooring coating in the construction field.

Thus, in a still further another aspect, the invention relates to the use of the composition or the mixture according to the invention as a coating material, Particularly as a flooring coat.

### DETAILED DESCRIPTION OF THE PRESENT INVENTION

Unless defined otherwise, all technical and scientific terms used herein have the meaning commonly understood by a person skilled in the art to which the invention belongs. As used herein, the following terms have the meanings ascribed to them below, unless specified otherwise.

As used herein, the articles “a” and “an” refer to one or to more than one (i.e., to at least one) of the grammatical object of the article. By way of example, “an element” means one element or more than one element.

As used herein, the term “about” is understood to refer to a range of numbers that a person of skill in the art would consider equivalent to the recited value in the context of achieving the same function or result.

As used herein, the term “methylene malonate” refers to a compound having the core formula —O—C(O)—C(═CH₂)—C(O)—O—.

As used herein, the term “two-component” refers to a composition comprising two components, each of which may also be a mixture of several compounds. The two components can be blended together if needed. And the two components may also be two independent packages that can be mixed on the spot for applications.

As used herein, the term “RH” is equal to “Relative Humidity” and refers to the ratio of the partial vapor pressure of water to the saturated vapor pressure of water at a given temperature.

As used herein, the term “substantial absence” as in “substantial absence of the solvent” refers to a reaction mixture which comprises less than 1% by weight of the particular component as compared to the total reaction mixture. In certain embodiments, the “substantial absence” refers to less than 0.7%, less than 0.5%, less than 0.4%, less than 0.3%, less than 0.2% or less than 0.1% by weight of the particular component as compared to the total reaction mixture. In certain other embodiments, the “substantial absence” refers to less than 1.0%, less than 0.7%, less than 0.5%, less than 0.4%, less than 0.3%, less than 0.2% or less than 0.1% by volume of the particular component as compared to the total reaction mixture.

As used herein, the term “stabilized,” e.g., in the context of “stabilized” monomers of the invention or compositions comprising the same, refers to the tendency of the monomers of the invention (or their compositions) to substantially not polymerize with time, to substantially not harden, form a gel, thicken, or otherwise increase in viscosity with time, and/or to substantially show minimal loss in cure speed (i.e., cure speed is maintained) with time as compared to similar compositions that are not stabilized.

As used herein, the term “shelf-life,” e.g., as in the context of the compositions of the invention having an improved “shelf-life,” refers to the compositions of the invention which are stabilized for a given period of time, e.g., 1 month, 6 months, or even 1 year or more.

As used herein, the term “additives” refers to additives included in a formulated system to enhance physical or chemical properties thereof and to provide a desired result. Such additives include, but are not limited to, dyes, pigments, toughening agents, impact modifiers, rheology modifiers, plasticizing agents, thixotropic agents, natural or synthetic rubbers, filler agents, reinforcing agents, thickening agents, opacifiers, inhibitors, fluorescence or other markers, thermal degradation reducers, thermal resistance conferring agents, defoaming agents, surfactants, wetting agents, dispersants, flow or slip aids, biocides, and stabilizers.

As used herein, the term “base” refers to a component having at least one electronegative group capable of initiating anionic polymerization.

As used herein the term “base precursor” refers to a component that may be converted to a base upon being acted upon in some manner, e.g., application of heat, chemical reaction, or UV activation.

As used herein, the term “base enhancer” refers to an agent that is capable of acting in some manner to improve or enhance the basicity of an agent.

As used herein, the term “halogen atom”, “halogen”, “halo-” or “Hal-” is to be understood as meaning a fluorine, chlorine, bromine or iodine atom.

As used herein, the term “alkyl”, either on its own or else in combination with further terms, for example haloalkyl, is understood as meaning a radical of a saturated aliphatic hydrocarbon group and may be branched or unbranched, for example methyl, ethyl, propyl, butyl, isobutyl, pentyl, hexyl, heptyl, octyl, nonyl, decyl, undecyl or dodecyl, or an isomer thereof.

As used herein, the term “alkenyl”, either on its own or else in combination with further terms, for example haloalkenyl, is understood as meaning a straight-chain or branched radical which has at least one double bond, for example vinyl, allyl, propenyl, butenyl, butadienyl, pentenyl, pentadienyl, hexenyl, or hexadienyl, or an isomer thereof.

As used herein, the term “alkynyl”, either on its own or else in combination with further terms, for example haloalkynyl, is understood as meaning a straight-chain or branched radical which has at least one triple bond, for example ethynyl, propynyl, or propargyl, or an isomer thereof.

As used herein, the term “cycloalkyl”, either on its own or else in combination with further terms, is understood as meaning a fused or non-fused, saturated, monocyclic or polycyclic hydrocarbon ring, for example cyclopropyl, cyclobutyl, cyclopentyl, cyclohexyl, cycloheptyl, or cyclooctyl, or an isomer thereof.

As used herein, the term “alkoxy”, either on its own or else in combination with further terms, for example haloalkoxy, is understood as meaning linear or branched, saturated, group having a formula —O-alkyl, in which the term “alkyl” is as defined above, for example methoxy, ethoxy, propoxy, butoxy, pentoxy, or hexoxy, or an isomer thereof.

As used herein, the term “aryl”, either on its own or else in combination with further terms, for example arylalkyl, is understood to include fused or non-fused aryl, such as phenyl or naphthyl, wherein phenyl is optionally substituted by 1 to 5 groups, and naphtyl is optionally substituted by 1 to 7 groups.

As used herein, the term “hetero-” is understood as meaning a saturated or unsaturated radical which is interrupted by at least one heteroatom selected from the group consisting of oxygen (O), nitrogen (N), and sulphur (S).

As used herein, the term “A- to B-member hetero-”, for example “3- to 6-member hetero-”, is understood as meaning a fused or non-fused, saturated or unsaturated monocyclic or polycyclic radical comprising, in addition to carbon atom, at least one heteroatom selected from the group consisting of oxygen (O), nitrogen (N), and sulphur (S), provided that the sum of the number of carbon atom and the number of heteroatom is within the range of A to B. The hetero groups according to this invention are preferably 5- to 30-member hetero groups, most preferably 6- to 18-member hetero groups, especially 6- to 12-member hetero groups, and particularly 6- to 8-member hetero groups.

As used herein, the term “heterocyclyl” is understood as including aliphatic or aromatic heterocyclyl, for example heterocyclylalkyl or heterocyclylalkenyl.

The term “substituted” means that one or more hydrogens on the designated atom is replaced with a selection from the indicated group, provided that the designated atom's normal valency under the existing circumstances is not exceeded, and that the substitution results in a stable compound. Combinations of substituents and/or variables are permissible only if such combinations result in stable compounds.

The term “optionally substituted” means optional substitution with the specified groups, radicals or moieties. Unless stated otherwise, optionally substituted radicals may be mono- or polysubstituted, where the substituents in the case of polysubstitution may be the same or different.

As used herein, halogen-substituted radicals, for example haloalkyl, are mono- or polyhalogenated, up to the maximum number of possible substituents. In the case of polyhalogenation, the halogen atoms can be identical or different. In this case, halogen is fluorine, chlorine, bromine or iodine.

As used herein, the groups with suffix “-ene” represent the groups have two covalent bond which could be linked to other radicals, for example —CH₂CH(CH₃)CH₂— (isobutylene),

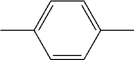

(phenylene), and in the case of phenylene, the covalent bond may be located in ortho-, meta-, or para-position.

Unless otherwise identified, all percentages (%) are “percent by weight”.

The radical definitions or elucidations given above in general terms or within areas of preference apply to the end products and correspondingly to the starting materials and intermediates. These radical definitions can be combined with one another as desired, i.e. including combinations between the general definition and/or the respective ranges of preference and/or the embodiments.

Unless otherwise identified, the temperature refers to room temperature and the pressure refers to ambient pressure.

Unless otherwise identified, the solvent refers to all organic and inorganic solvents known to the persons skilled in the art and does not include any type of monomer molecular.

In one aspect, the invention provides a composition comprising Component I comprising

1. A two-component composition comprising Component I comprising

(A) at least one methylene malonate monomer having formula (I)

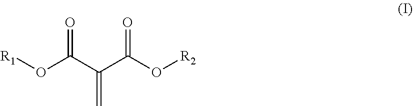

wherein R₁ and R₂ are in each case independently selected from the group consisting of C1-C30-alkyl, C2-C30-alkenyl, C3-C30-cyclolalkyl, C2-C30-heterocyclyl, C2-C30-heterocyclyl-(C1-C30-alkyl), C6-C30-aryl, C6-C30-aryl-C1-C30-alkyl, C2-C30-heteroaryl, C2-C30-heteroaryl-C1-C30-alkyl, and C1-C30-alkoxy-C1-C30-alkyl, halo-C1-C30-alkyl, halo-C3-C30-cyclolalkyl, each of which radicals is optionally substituted, the heteroatom being selected from N, O and S;

(B) at least one methylene malonate polymer having formula (II)

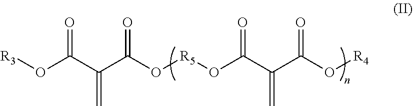

wherein, R₃ and R₄ are, in each case independently selected from the group consisting of C1-C30-alkyl, C2-C30-alkenyl, C3-C30-cyclolalkyl, C2-C30-heterocyclyl, C2-C30-heterocyclyl-C1-C30-alkyl, C6-C30-aryl, C6-C30-aryl-(C1-C30-alkyl), C2-C30-heteroaryl, C2-C30-heteroaryl-C1-C30-alkyl, C1-C30-alkoxy-C1-C30-alkyl, halo-C1-C30-alkyl, and halo-C3-C30-cyclolalkyl, each of which radicals is optionally substituted, the heteroatom being selected from N, O and S;

n is an integer from 1 to 20;

R₅, if n=1 is, or if n>1 are in each case independently, selected from the group consisting of C1-C30-alkylene, C2-C30-alkenylene, C2-C30-alkynylene, C6-C30-arylene, C3-C30-cyclolalkylene, C3-C30-cyclolalkenylene, C3-C30-cyclolalkynylene, C2-C30-heterocyclylene, and C2-C30-heteroarylene, each of which radicals is optionally substituted, and the heteroatom being selected from N, O and S, wherein R₅ is optionally interrupted by a radical selected from N, O and S; and

(C) at least one acidic stabilizer;

and Component II comprising at least one alkali accelerator,

wherein, the monomer (A) is in an amount of from 0 to 40 wt. %, preferably from 5 to 35 wt. % and more preferably from 10 to 30 wt. %, and most preferably 15 to 20 wt. %, in each case based on the total weight of the monomer (A) and the polymer (B);

the acidic stabilizer (C) is in an amount of from 0.1 to 500 ppm, preferably from 0.1 to 300 ppm and more preferably from 0.1 to 200 ppm; and

the component II is in an amount of from 0.01 to 10 wt. %, preferably from 0.05 to 5 wt. % and more preferably from 0.1 to 2 wt. %, in each case based on the total weight of the monomer (A) and the polymer (B).

In a preferred embodiment of the invention, R₁ and R₂ are in each case independently selected from the group consisting of C1-C10-alkyl, C2-C10-alkenyl, C3-C10-cyclolalkyl, C2-C10-hetercyclyl, C2-C10-hetercyclyl-C1-C10-alkyl, C3-C18-aryl, C3-C18-aryl-C1-C10-alkyl, C2-C10-heteroaryl, C2-C10-heteroaryl-C1-C10-alkyl, and C1-C10-alkoxy-C1-C10-alkyl, halo-C1-C10-alkyl, and halo-C3-C10-cyclolalkyl, each of which radicals is optionally substituted, the heteroatom being selected from N, O and S.

Preferably, R₁ and R₂ are in each case independently selected from the group consisting of C1-C6-alkyl, C2-C6-alkenyl, C3-C6-cyclolalkyl, C3-C6-hetercyclyl, C3-C6-hetercyclyl-C1-C6-alkyl, C6-C8-aryl, C6-C8-aryl-C1-C6-alkyl, C3-C6-heteroaryl, C3-C6-heteroaryl-C1-C6-alkyl, C1-C6-alkoxy-C1-C6-alkyl, halo-C1-C10-alkyl, and halo-C3-C10-cyclolalkyl, each of which radicals is optionally substituted, the heteroatom being selected from N, O and S.

More preferably, R₁ and R₂ are in each case independently selected from the group consisting of C1-C6-alkyl, for example methyl, ethyl, n- or isopropyl, n-, iso-, tert- or 2-butyl, pentyls such as n-pentyl and isopentyl, hexyls such as n-hexyl, isohexyl and 1,3-dimethylbutyl.

More preferably, R₁ and R₂ are in each case independently selected from the group consisting of linear C1-C6-alkyl, for example methyl, ethyl, n-propyl, n-butyl, n-pentyl, n-hexyl.

In a preferred embodiment of the invention, R₃ and R₄ are in each case independently selected from the group consisting of C1-C10-alkyl, C2-C10-alkenyl, C3-C10-cyclolalkyl, C2-C10-hetercyclyl, C2-C10-hetercyclyl-C1-C10-alkyl, C3-C18-aryl, C3-C18-aryl-C1-C10-alkyl, C2-C10-heteroaryl, C2-C10-heteroaryl-C1-C10-alkyl, and C1-C10-alkoxy-C1-C10-alkyl, halo-C1-C10-alkyl, and halo-C3-C10-cyclolalkyl, each of which radicals may be optionally substituted, the heteroatom being selected from N, O and S.

Preferably, R₃ and R₄ are in each case independently selected from the group consisting of C1-C6-alkyl, C2-C6-alkenyl, C3-C6-cyclolalkyl, C3-C6-hetercyclyl, C3-C6-hetercyclyl-C1-C6-alkyl, C6-C8-aryl, C6-C8-aryl-C1-C6-alkyl, C3-C6-heteroaryl, C3-C6-heteroaryl-C1-C6-alkyl, C1-C6-alkoxy-C1-C6-alkyl, halo-C1-C10-alkyl, and halo-C3-C10-cyclolalkyl, each of which radicals may optionally substituted, the heteroatom being selected from N, O and S.

More preferably, R₃ and R₄ are in each case independently selected from the group consisting of C1-C6-alkyl, for example methyl, ethyl, n- or isopropyl, n-, iso-, tert- or 2-butyl, pentyls such as n-pentyl and isopentyl, hexyls such as n-hexyl, isohexyl and 1,3-dimethylbutyl.

More preferably, R₃ and R₄ are in each case independently selected from the group consisting of linear C1-C6-alkyl, for example methyl, ethyl, n-propyl, n-butyl, n-pentyl, n-hexyl.

In a preferred embodiment of the invention, R₁, R₂, R₃ and R₄ are the same.

In a preferred embodiment of the invention, n is preferably from 1 to 15, more preferably from 1 to 10, much more preferably from 1 to 8, especially preferably from 2 to 8, most preferably from 3 to 6.

In a preferred embodiment of the invention, R₅, if n=1 is, or if n>1 are in each case independently, selected from the group consisting of C1-C10-alkylene, C2-C10-alkenylene, C2-C10-alkynylene, C3-C18-arylene, C3-C10-cyclolalkylene, C3-C10-cyclolalkenylene, C3-C10-cyclolalkynylene, C2-C10-hetercyclylene, and C2-C10-heteroarylene, each of which radicals is optionally substituted, the heteroatom being selected from N, O and S, wherein R₅ is optionally interrupted by a radical selected from N, O and S; and

Preferably, R₅, if n=1 is, or if n>1 are in each case independently, selected from the group consisting of C1-C6-alkylene, C2-C6-alkenylene, C2-C6-alkynylene, C6-C8-arylene, C3-C6-cyclolalkylene, C3-C6-cyclolalkenylene, C3-C10-cyclolalkynylene, C3-C6-hetercyclylene, and C3-C6-heteroarylene, each of which radicals is optionally substituted, the heteroatom being selected from N, O and S, wherein R₅ is optionally interrupted by a radical selected from N, O and S; and

More preferably, R₅, if n=1 is, or if n>1 are in each case independently, selected from the group consisting of C1-C6-alkylene and C6-C8-arylene, each of which radicals is optionally substituted by at least one C1-C6-alkyl.

Most preferably, R₅, if n=1 is, or if n>1 are in each case independently, selected from the group consisting of propylidene, pentylidene and phenylene, each of which radicals is optionally substituted by methyl.

Particularly, R₅ may be phenylene. It can be linked to other radicals in the main chain in its ortho-, meta-, or para-position, preferably para-position, i.e.

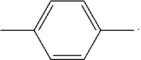

In a preferred embodiment of the invention, the radicals may be further substituted by substituents. Possible substituents may be selected from the group consisting of halogen, hydroxyl, nitro, cyano, C1-C10-alkyl, C2-C10-alkenyl, C2-C10-alkynyl, C1-C10-alkoxy, C3-C10-cyclolalkyl, C2-C10-hetercyclyl, C2-C10-hetercyclyl-C1-C10-alkyl, halo-C1-C10-alkyl, halo-C3-C10-cyclolalkyl, C3-C18-aryl, C3-C18-aryl-C1-C10-alkyl, C2-C10-heteroaryl, C3-C10-cyclolalkenyl, and C3-C10-cyclolalkynyl, wherein the heteroatom is selected from N, O and S.

Preferably, the substituents may be selected from the group consisting of halogen, hydroxyl, nitro, cyano, C1-C6-alkyl, C2-C6-alkenyl, C2-C6-alkynyl, C1-C6-alkoxy, C3-C6-cyclolalkyl, C3-C6-hetercyclyl, C3-C6-hetercyclyl-C1-C6-alkyl, halo-C1-C6-alkyl, halo-C3-C6-cyclolalkyl, C6-C8-aryl, C6-C8-aryl-C1-C6-alkyl, C3-C6-heteroaryl, C3-C6-cyclolalkenyl, and C3-C6-cyclolalkynyl, wherein the heteroatom is selected from N, O and S.

In a preferred embodiment of the invention, the composition has an elongation rate (%), a tensile strength (MPa), a weight loss (mg) after 400 cycle's milling concerning the abrasion resistance, and they satisfy the following relation:

1.05<(2 ER/[%]+TS/[Mpa])/AR [mg]<2.25.

wherein, ER is an abbreviation of the elongation rate, which is determined according to DIN 53504, TS is an abbreviation of the tensile strength, which is determined according to DIN 53504, and AR is an abbreviation of the weight loss (mg) after 400 cycle's milling concerning abrasion resistance, which is determined according to ASTM D 4060-07. Hereinafter, the abbreviations “ER”, “TS” and “AR” have the same meanings.

More Preferably, the following relation is meet: 1.15<(2 ER/[%]+TS/[Mpa])/AR[mg]<1.85 and most preferably, the following relation is meet:

1.25<(2 ER/[%]+TS/[Mpa])/AR [mg]<1.75.

Surprisingly, it has been found by the inventor that a suitable amount of the monomer and the polymer or of the respective components in the composition leads to an excellent balance of the properties desired by a construction material, such as workability, physical and chemical resistance, tensile strength and abrasion resistance, and the like.

In each case, the compositions of the invention shall include one or more compounds to extend the shelf-life. In certain embodiments, the compositions are formulated such that the composition is stable for at least 6 months and preferably, is stable for at least one year. Said compounds comprise acidic stabilizer.

The present invention contemplates any suitable acidic stabilizer known in the art, including, for example, sulfuric acid (H₂SO₄), trifluoromethane sulfonic acid (TFA), chlorodifluoro acid, maleic acid, methane sulfonic acid (MSA), p-toluenesulfonic acid (p-TSA), difluoro acetic acid, trichloroacetic acid, phosphoric acid, dichloroacetic acid or like acid. Acidic stabilizers can include any material which can be added to the monomer or polymer compositions to extend shelf-life, e.g., by up to, for example, 1 year or more. Such acidic stabilizers may have a pKa in the range of, for example, between about −15 to about 5, or between about −15 to about 3, or between about −15 to about 1, or between about −2 to about 2, or between about 2 to about 5, or between about 3 to about 5.

For each of these acidic stabilizing materials, such acidic stabilizer can be present in an amount of from 0.1 to 500 ppm, preferably from 0.5 to 400, more preferably from 1 to 300 ppm, much more preferably from 5 to 250 ppm, and much more preferably from 10 to 200 ppm, and still more preferably from 30 to 180, and most preferably from preferably from 50 to 150 ppm.

According to an embodiment of the invention, the composition may further include an alkali accelerator

According to a preferred embodiment of the invention, the alkali accelerator is in a form of a base, a base precursor, or a base enhance. Preferably, the alkali accelerator is at least one selected from metallic oxide, metallic hydroxide, amine, guanidine, amide, piperidine, piperazine, morpholine, pyridine, halides, salts of metal, ammonium, amine, wherein the anions in said salts is at least one selected from halogens, acetates, chloracetates, benzoates, aliphatic acids, alkene carboxylic acids, sulfurs, carbonates, silicates, diketones, monocarboxylic acids, polymers containing carboxylic acids.

And more preferably, the alkali accelerator is at least one selected from dimethylethylamine, dimethylpropylamine, 2-ethylhexylamine, di-(2-ethylhexyl)amine, dibutylamine, dicyclohexylamine, ditridecylamine mixture of isomers, N,N-dimethylisopropylamine, N-ethyldiisopropylamine, N,N-dimethylcyclohexylamine, N-Octylamine, tributylamine, tridecylamine mixture of isomers, tripropylamine, tris-(2-ethylhexyl)amine, triethylamine, trimethylamine, 2-(diisopropylamino)ethylamine, 3-(cyclohexylamino)propylamine, 3-(diethylamino)propylamine, 3,3′-dimethyl-4,4′-diaminodicyclohexylmethane, 4,4′-diaminodicyclohexylmethane, isophorone diamine, tetramethyl-1,6-hexanediamine, S-triazine, neopentanediamine (2,2-Dimethylpropane-1,3-diamine), octamethylenediamine, diethylenetriamine, dipropylene triamine, pentamethyldietylenetriamine, N,N-Bis-(3-aminopropyl)methylamine, N3-Amine 3-(2-Aminoethylamino)propylamine, N4-Amine N,N′-Bis-(3-Aminopropyl)ethylenediamine, 4,9-Dioxadodecane-1,12-diamine, di-(2-methoxyethyl)amine, bis(2-dimethylaminoethyl) ether, polyetheramine D 2000, polyetheramine D 230, polyetheramine D 400, polyetheramine T 403, polyetheramine T 5000, N,N-Dimethylcyclohexylamine, N-methylmorpholine, 2,2′-Dimorpholinodiethylether, dimethylaminoethoxyethanol, bis(2-dimethylaminoethyl)ether, pentamethyldietylenetriamine, trimethylaminoethylethanolamine, tetramethyl-1,6-hexanediamine, 1,8-diazabicyclo-5,4,0-undecene-7, 2,6-xylidine, 2-phenylethylamine, 4,4′-diaminodiphenylmethane, aniline, benzylamine, tris(dimethylaminomethyl)phenol, 2-dimethylaminomethylphenol (DMP10), diethanol-para-toluidine, diisopropanol-p-toluidine, N-(2-hydroxyethyl)aniline, N,N-di-(2-hydroxyethyl)aniline, N-ethyl-N-(2-hydroxyethyl)aniline, o-toluidine, p-nitrotoluene, 3-dimethylaminopropane-1-ol, butyldiethanolamine, triisopropanolamine, dibutylethanolamine, diethylethanolamine, methyldiethanolamine, methyldiisopropanolamine, N,N-dimethylethanolamine S, N,N-dimethylisopropanolamine, dimethylethanolamine, 4-(2-hydroxyethyl)morpholine, N,N,N′,N′-Tetrakis(2-hydroxyethyl)ethylenediamine, sodium acetate, potassium acetate, zinc acetate, copper acetate, magnesium acetate, aluminium acetate, sodium chloracetate, potassium chloracetate, copper chloracetate, zinc chloracetate, magnesium chloracetate, aluminium chloracetate, ferric chloracetate, acid salts of sodium, potassium, lithium, copper, iron and cobalt, sodium oxide, potassium oxide, calcium oxide, zinc oxide, copper oxide, magnesium oxide, aluminium oxide, ferric and ferrous oxide, sodium hydroxide, potassium hydroxide, zinc hydroxide, copper hydroxide, magnesium hydroxide, aluminium hydroxide, calcium hydroxide, ferric and ferrous hydroxide, sodium silicate, potassium silicate, zinc silicate, copper silicate, magnesium silicate iron silicate, aluminium silicate, lithium chloride and tetramethyl guanidine.

According to a preferred embodiment of the invention, the required amount of alkali accelerator may be present in an amount of from 0.01 to 10 wt. %, preferably from 0.05 to 5 wt. % and more preferably from 0.1 to 2 wt. %, and most preferably from 0.5 to 1%, in each case based on the total weight of the monomer (A) and the polymer (B).

According to an embodiment of the invention, the mixture comprises the two-component composition according to the invention.

According to an embodiment of the invention, the mixture comprising the composition according to the invention is substantial absence of any solvent.

According to an embodiment of the invention, the mixture comprising the composition according to the invention may further include other additives.

In certain embodiments of the invention, the other additives may be at least one selected from plasticizers, thixotropic agents, adhesion promoters, antioxidants, light stabilizers, UV stabilizer, filler, cement, lime stone, surfactant, wetting agents, viscosity modifier, extenders, dispersants, anti-blocking agents, air release agents, anti-sagging agents, anti-setting agents, matting agents, flattening agents, waxes, anti-mar additives, anti-scratch additives, defoaming agent, or inert resins. In a preferred embodiment of the invention, the additives may be at least one selected from plasticizers, thixotropic agents, adhesion promoters, antioxidants, light stabilizers, UV stabilizer, filler, cement, lime stone, surfactant, wetting agents, viscosity modifier, dispersants, air release agents, anti-sagging agents, anti-setting agents, defoaming agent, coloring agent, fiber, polymer powder, mesh, chip, hollow spheres and inert resins

For those skilled in the art, the above additives are commercially available. The above formulation additives, if any, are presented in an amount commonly used in the art.

In other embodiments of the invention, the mixture comprising the composition according to the invention may further include a coloring agent, including, but not limited to, organic pigment, organo-metallic pigment, mineral-based pigment, carbon pigments, titanium pigment, azo compound, quinacridone compound, phthalocyanine compound, cadmium pigment, chromium pigment, cobalt pigment, copper pigment, iron pigment, clay earth pigment, lead pigment, mercury pigment, titanium pigment, aluminum pigment, manganese pigment, ultramarine pigment, zinc pigment, arsenic pigment, tin pigment, iron oxide pigment, antimony pigment, barium pigment, a biological pigment, dye, photochromic, conductive and liquid crystal polymer pigment, piezochromic pigment, goniochromatic pigment, silver pigment, diketopyrrolo-pyrrole, benzimidazolone, isoindoline, isoindolinone, radio-opacifier and the like.

For those skilled in the art, the above coloring agents are commercially available. The above coloring agents, if any, are presented in an amount commonly used in the art.

The definitions and description concerning the composition also apply to the process and use of the present invention.

The composition according to the invention may be obtained by a process comprising steps of:

(1) mixing the monomer (A), the polymer (B) and the acidic stabilizer (C) to obtain component I; and

(2) preparing the component II.

In a preferred embodiment, the process for preparing the composition according to the invention comprises a) mixing the monomer (A) and the polymer (B) in amounts as described in the above; b) adding the acidic stabilizer (C) into the mixture obtained from step (a); and c) adding alkali accelerator and other additives into the mixture obtained from step (b).

The mixing used in the process is carried out by conventional means in the art in a unit suitable for mixing, for example, by stirring or agitating at a room temperature.

According to specifically aspects of the invention, the methylene malonate monomer having formulas (I) or (II) could be prepared by those skilled in the art by means of the following steps: (a) reacting a malonic acid ester with a source of formaldehyde, optionally in the presence of an acidic or basic catalyst, and optionally in the presence of an acidic or non-acidic solvent, to form a reaction mixture; (b) contacting the reaction mixture or a portion thereof with an energy transfer means to produce a vapor phase comprising methylene malonate monomer; and (c) isolating the methylene malonate monomer from the vapor phase.

According to an embodiment of the invention, the polymer (B) having formula (II) could be prepared by those skilled in the art by means of the following steps: An appropriate amount of starting material (e.g., DEMM) and an appropriate amount of OH-containing linking group (e.g., diol) are mixed and reacted in the presence of a catalyst (e.g., Novazym 435), and the resulting mixture is stirred and heated for a period of time at a certain temperature, while the alcohol generated was removed by evaporation. Subsequently, the reaction mixture was cooled and stabilized with a minor amount of acid stabilizer, and then filtered to obtain the desired product.

In an aspect, the invention relates to the use of the composition according to the invention as a coating material, particularly as a flooring coat.

The two-component composition or the mixture is applied on a substrate selected from concrete, wood, resin layer and stone and the resin layer is selected from cement-based resin layer, epoxy-based resin layer, polyurethane-based resin layer, acrylate-based resin layer, polyethylene layer, polypropylene layer, polyvinylchloride, rubber layer, bitumen layer and polymer-modified bitumen layer.

Component I and component II are mixed before applying onto substrates or component II is applied onto substrates first and component I is applied onto substrates in next step.

The temperature for the use is from −30° C. to 60° C. and preferably from −20° C. to 40° C. And the relative humidity for the use is from 1% to 99% and preferably from 5% to 95%.

The composition according to the invention may be applied in a conventional way in the art. In a preferred embodiment, the monomer (A) and the polymer (B) are mixed with the acidic stabilizer (C) and additives such as filler or UV stabilizer to give a ready-made formulation, and then adding an alkali accelerator such as triethylamine into the system and applying the mixture onto the substrates. In a still preferred embodiment, the monomer (A) and the polymer (B) were firstly placed in a suitable vessel, and the acidic stabilizer (C) was added into the vessel, thereby giving a ready-made formulation; subsequently, the alkali accelerator was coated on a flooring substrate, and then the ready-made formulation was applied on the coated substrate.

In the present invention, coating or applying may be carried out in a way known to those skilled in the art, for example by brushing, spraying, or roll coating. It is noted that the specific way of coating or applying used in the present invention depends on the workability of the composition; particularly, long gel time is needed for roller coating, whereas short gel time is needed for spray coating.

In the embodiments of the present invention, the flooring substrates to be coated comprise a concrete, wood, resin layer and cement-based resin layer. In a preferred embodiment, the resin layer comprises cement-based resin layer, epoxy-based resin layer, polyurethane-based resin layer, acrylate-based resin layer, polyethylene layer, polypropylene layer, polyvinylchloride, rubber layer, bitumen layer and polymer-modified bitumen layer.

In the embodiments of the present invention, the two-component composition or the mixture is applied on wet substrates.

In the embodiments of the present invention, the temperature for the use is from −30° C. to 60° C. and preferably from −20° C. to 40° C.

In the embodiments of the present invention, the relative humidity for the use is from 1% to 99% and preferably from 5% to 95%.

### Embodiment

The following embodiments are used to illustrate the invention in more detail.

The 1^{st} embodiment is a two-component composition comprising Component I comprising

(A) at least one methylene malonate monomer having formula (I):

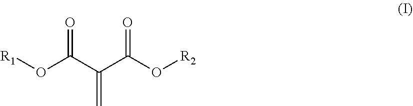

wherein, R₁ and R₂ are in each case independently selected from the group consisting of C1-C30-alkyl, C2-C30-alkenyl and C3-C30-cyclolalkyl;

(B) at least one methylene malonate polymer having formula (II):

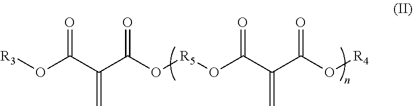

wherein, R₃ and R₄ are in each case independently selected from the group consisting of C1-C30-alkyl, C2-C30-alkenyl and C3-C30-cyclolalkyl;

n is an integer from 2 to 8; and

R₅, if n=1 is, or if n>1 are in each case independently, selected from the group consisting of C1-C30-alkylene and C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Component II comprising at least one selected from dimethylethylamine, dimethylpropylamine, 2-ethylhexylamine, di-(2-ethylhexyl)amine, dibutylamine, dicyclohexylamine, ditridecylamine mixture of isomers, N,N-dimethylisopropylamine, N-ethyldiisopropylamine, N,N-dimethylcyclohexylamine, N-Octylamine, tributylamine, tridecylamine mixture of isomers, tripropylamine, tris-(2-ethylhexyl)amine, triethylamine, trimethylamine, 2-(diisopropylamino)ethylamine, 3-(cyclohexylamino)propylamine, 3-(diethylamino)propylamine, 3,3′-dimethyl-4,4′-diaminodicyclohexylmethane, 4,4′-diaminodicyclohexylmethane, isophorone diamine, tetramethyl-1,6-hexanediamine, S-triazine, neopentanediamine (2,2-Dimethylpropane-1,3-diamine), octamethylenediamine, diethylenetriamine, dipropylene triamine, pentamethyldietylenetriamine, N,N-Bis-(3-aminopropyl)methylamine, N3-Amine 3-(2-Aminoethylamino)propylamine, N4-Amine N,N′-Bis-(3-Aminopropyl)ethylenediamine, 4,9-Dioxadodecane-1,12-diamine, di-(2-methoxyethyl)amine, bis(2-dimethylaminoethyl) ether, polyetheramine D 2000, polyetheramine D 230, polyetheramine D 400, polyetheramine T 403, polyetheramine T 5000, N,N-Dimethylcyclohexylamine, N-methylmorpholine, 2,2′-Dimorpholinodiethylether, dimethylaminoethoxyethanol, bis(2-dimethylaminoethyl)ether, pentamethyldietylenetriamine, trimethylaminoethylethanolamine, tetramethyl-1,6-hexanediamine, 1,8-diazabicyclo-5,4,0-undecene-7, 2,6-xylidine, 2-phenylethylamine, 4,4′-diaminodiphenylmethane, aniline, benzylamine, tris(dimethylaminomethyl)phenol, 2-dimethylaminomethylphenol (DMP10), diethanol-para-toluidine, diisopropanol-p-toluidine, N-(2-hydroxyethyl)aniline, N,N-di-(2-hydroxyethyl)aniline, N-ethyl-N-(2-hydroxyethyl)aniline, o-toluidine, p-nitrotoluene, 3-dimethylaminopropane-1-ol, butyldiethanolamine, triisopropanolamine, dibutylethanolamine, diethylethanolamine, methyldiethanolamine, methyldiisopropanolamine, N,N-dimethylethanolamine S, N,N-dimethylisopropanolamine, dimethylethanolamine, 4-(2-hydroxyethyl)morpholine, N,N,N′,N′-Tetrakis(2-hydroxyethyl)ethylenediamine, sodium acetate, potassium acetate, zinc acetate, copper acetate, magnesium acetate, aluminium acetate, sodium chloracetate, potassium chloracetate, copper chloracetate, zinc chloracetate, magnesium chloracetate, aluminium chloracetate, ferric chloracetate, acid salts of sodium, potassium, lithium, copper, iron and cobalt, sodium oxide, potassium oxide, calcium oxide, zinc oxide, copper oxide, magnesium oxide, aluminium oxide, ferric and ferrous oxide, sodium hydroxide, potassium hydroxide, zinc hydroxide, copper hydroxide, magnesium hydroxide, aluminium hydroxide, calcium hydroxide, ferric and ferrous hydroxide, sodium silicate, potassium silicate, zinc silicate, copper silicate, magnesium silicate iron silicate, aluminium silicate, lithium chloride and tetramethyl guanidine,

wherein, the monomer (A) is in an amount of 0 to 40 wt. %, and the acidic stabilizer (C) is in an amount of 0.1 to 500 ppm, and the component II is in an amount of 0.01 to 10 wt. %, in each case based on the total weight of the monomer (A) and the polymer (B).

The 2^{nd} embodiment is a two-component composition comprising Component I comprising

(A) at least one methylene malonate monomer having formula (I)

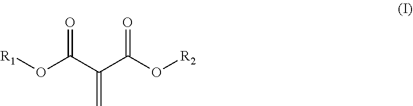

wherein, R₁ and R₂ are in each case independently selected from the group consisting of C2-C30-alkenyl, C2-C30-alkenyl and C3-C30-cyclolalkyl;

(B) at least one methylene malonate polymer having formula (II):

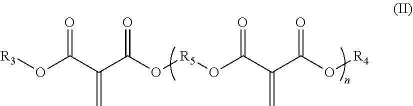

wherein, R₃ and R₄ are in each case independently selected from the group consisting of C1-C30-alkyl, C2-C30-alkenyl and C3-C30-cyclolalkyl;

n is an integer from 2 to 8; and

R₅, if n=1 is, or if n>1 are in each case independently, selected from the group consisting of C1-C30-alkylene and C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Component II comprising at least one selected from calcium hydroxide, sodium silicate, sodium propionate, sodium benzoate, 2-dimethylaminomethylphenol (DMP10), N,N,N′,N′-Tetrakis(2-hydroxyethyl)ethylenediamine, lithium chloride, 2,2′-Dimorpholinodiethylether, wherein, the monomer (A) is in an amount of 5 to 35 wt. %, and the acidic stabilizer (C) is in an amount of 0.1 to 400 ppm, and the component II is in an amount of 0.01 to 5 wt. %, in each case based on the total weight of the monomer (A) and the polymer (B).

The 3^{rd} embodiment is a two-component composition comprising Component I comprising

(A) at least one methylene malonate monomer having formula (I):

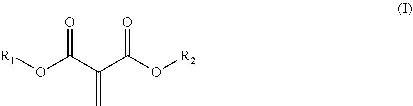

wherein, R₁ and R₂ are in each case independently selected from the group consisting of C2-C30-alkenyl, C2-C30-alkenyl and C3-C30-cyclolalkyl;

(B) at least one methylene malonate polymer having formula (II):

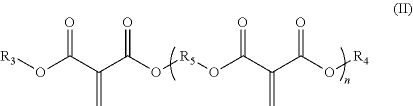

wherein, R₃ and R₄ are in each case independently selected from the group consisting of C1-C30-alkyl, C2-C30-alkenyl and C3-C30-cyclolalkyl;

n is an integer from 2 to 8; and

R₅, if n=1 is, or if n>1 are in each case independently, selected from the group consisting of C1-C30-alkylene and C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Component II comprising at least one selected from 2-(diisopropylamino)ethylamine, 3-(cyclohexylamino)propylamine, 3-(diethylamino)propylamine, 3,3′-dimethyl-4,4′-diaminodicyclohexylmethane, 4,4′-diaminodicyclohexylmethane, isophorone diamine, tetramethyl-1,6-hexanediamine, neopentanediamine (2,2-Dimethylpropane-1,3-diamine), octamethylenediamine,

wherein, the monomer (A) is in an amount of 5 to 35 wt. %, and the acidic stabilizer (C) is in an amount of 0.1 to 300 ppm, and the component II is in an amount of 0.05 to 5 wt. %, in each case based on the total weight of the monomer (A) and the polymer (B).

The 4^{th} embodiment is a two-component composition comprising Component I comprising

(A) at least one methylene malonate monomer having formula (I)

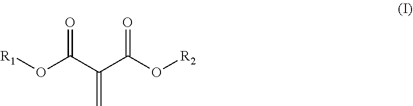

wherein, R₁ and R₂ are in each case independently selected from the group of C6-C30-aryl;

(B) at least one methylene malonate polymer having formula (II):

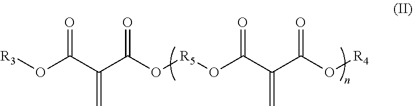

wherein, R₃ and R₄ are in each case independently selected from the group of C1-C30-alkyl,

n is an integer from 2 to 8; and

R₅, if n=1 is, or if n>1 are in each case independently, selected from the group consisting of C1-C30-alkylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Component II comprising at least one selected from 2-ethylhexylamine, N-Octylamine, tridecylamine, 3,3′-dimethyl-4,4′-diaminodicyclohexylmethane, 4,4′-diaminodicyclohexylmethane, isophorone diamine, neopentanediamine (2,2-Dimethylpropane-1,3-diamine), octamethylenediamine, dibutylethanolamine, 4,4′-diaminodiphenylmethane, benzylamine, polyetheramine D 2000, polyetheramine D 230, polyetheramine D 400, polyetheramine T 403, polyetheramine T 5000, di-(2-ethylhexyl)amine, dibutylamine, dicyclohexylamine, ditridecylamine, 4,9-Dioxadodecane-1,12-diamine, di-(2-methoxyethyl)amine, dimethylethylamine, dimethylpropylamine, N,N-dimethylisopropylamine, N-Ethyldiisopropylamine, N,N-dimethylcyclohexylamine, trimethylamine, triethylamine, tripropylamine, tributylamine, tris-(2-ethylhexyl)amine, 2-(diisopropylamino)ethylamine, tetramethyl-1,6-hexanediamine, S-triazine, pentamethyldietylenetriamine, bis(2-dimethylaminoethyl) ether, N,N-Dimethylcyclohexylamine, bis(2-dimethylaminoethyl)ether, pentamethyldietylenetriamine, trimethylaminoethylethanolamine, tetramethyl-1,6-hexanediamine, tris(dimethylaminomethyl)phenol, 2-dimethylaminomethylphenol (DMP10), 3-(cyclohexylamino)propylamine, diethylenetriamine, dipropylene triamine, 3-(2-aminoethylamino)propylamine, N,N′-Bis-(3-Aminopropyl)ethylenediamine, 3-(diethylamino)propylamine, N,N-Bis-(3-aminopropyl)methylamine, butyldiethanolamine, triisopropanolamine, diethylethanolamine, methyldiethanolamine, methyldiisopropanolamine, N,N-dimethylethanolamine S, N,N-dimethylisopropanolamine, dimethylethanolamine, N,N,N′,N′-Tetrakis(2-hydroxyethyl)ethylenediamine, dimethylaminoethoxyethanol, diethanol-para-toluidine, diisopropanol-p-toluidine, 3-dimethylaminopropane-1-ol, 2,6-xylidine, 2-phenylethylamine, aniline, N-(2-hydroxyethyl)aniline, N,N-di-(2-hydroxyethyl)aniline, N-ethyl-N-(2-hydroxyethyl)aniline, o-toluidine, p-nitrotoluene,

wherein, the monomer (A) is in an amount of 5 to 30 wt. %, and the acidic stabilizer (C) is in an amount of 0.1 to 250 ppm, and the component II is in an amount of 0.05 to 5 wt. %, in each case based on the total weight of the monomer (A) and the polymer (B).

The 5^{th} embodiment is a two-component composition comprising Component I comprising

(A) at least one methylene malonate monomer having formula (I):

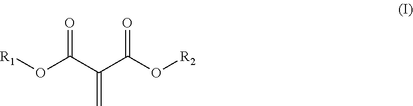

wherein, R₁ and R₂ are in each case independently selected from the group of C1-C30-alkyl,

(B) at least one methylene malonate polymer having formula (II):

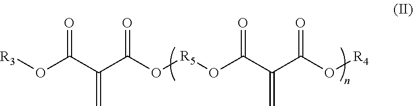

wherein, R₃ and R₄ are in each case independently selected from the group of C1-C30-alkyl;

n is an integer from 3 to 6; and

R₅, if n=1 is, or if n>1 are in each case independently, selected from the group consisting of C1-C30-alkylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Component II comprising at least one selected from sodium acetate, potassium acetate, zinc acetate, copper acetate, magnesium acetate, aluminum acetate, sodium chloracetate, potassium chloracetate, copper chloracetate, zinc chloracetate, magnesium chloracetate, aluminum chloracetate, sodium silicate, potassium silicate, zinc silicate, copper silicate, magnesium silicate and aluminum silicate, sodium propionate, potassium propionate, zinc propionate, copper propionate, magnesium propionate and aluminum propionate, sodium sorbate, potassium sorbate, zinc sorbate, copper sorbate, magnesium sorbate and aluminum sorbate, sodium benzoate, potassium benzoate, zinc benzoate, copper benzoate, magnesium benzoate and aluminum benzoate,

wherein, the monomer (A) is in an amount of 10 to 30 wt. %, and the acidic stabilizer (C) is in an amount of 0.1 to 200 ppm, and the component II is in an amount of 0.05 to 5 wt. %, in each case based on the total weight of the monomer (A) and the polymer (B).

The 6^{th} embodiment is a two-component composition comprising Component I comprising

(A) at least one methylene malonate monomer having formula (I):

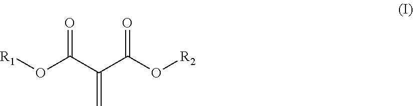

wherein, R₁ and R₂ are in each case independently selected from the group of C1-C30-alkyl;

(B) at least one methylene malonate polymer having formula (II):

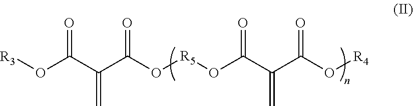

wherein, R₃ and R₄ are in each case independently selected from the group consisting of C1-C30-alkyl,

n is an integer from 3 to 6; and

R₅, if n=1 is, or if n>1 are in each case independently, selected from the group consisting of C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Component II comprising at least one selected from sodium hydroxide, potassium hydroxide, zinc hydroxide, copper hydroxide, magnesium hydroxide, aluminum hydroxide, calcium hydroxide,

wherein, the monomer (A) is in an amount of 15 to 20 wt. %, and the acidic stabilizer (C) is in an amount of 0.1 to 180 ppm, and the component II is in an amount of 0.05 to 2 wt. %, in each case based on the total weight of the monomer (A) and the polymer (B).

The 7^{th} embodiment is a two-component composition comprising Component I comprising

(A) at least one methylene malonate monomer having formula (I):

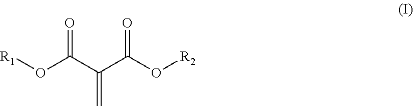

wherein, R₁ and R₂ are in each case independently selected from the group consisting of C1-C30-alkyl, C2-C30-alkenyl and C3-C30-cyclolalkyl

(B) at least one methylene malonate polymer having formula (II):

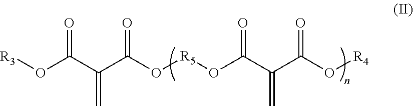

wherein, R₃ and R₄ are in each case independently selected from the group consisting of C1-C30-alkyl, C2-C30-alkenyl and C3-C30-cyclolalkyl

n is an integer from 2 to 8; and

R₅, if n=1 is, or if n>1 are in each case independently, selected from the group consisting of C1-C30-alkylene and C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Component II comprising at least one selected from 4,9-dioxadodecane-1,12-diamine, di-(2-methoxyethyl)amine, bis(2-dimethylaminoethyl) ether, polyetheramine D 2000, polyetheramine D 230, polyetheramine D 400, polyetheramine T 403, polyetheramine T 5000, wherein, the monomer (A) is in an amount of 5 to 35 wt. %, and the acidic stabilizer (C) is in an amount of 0.1 to 200 ppm, and the component II is in an amount of 0.01 to 10 wt. %, in each case based on the total weight of the monomer (A) and the polymer (B).

The 8^{th} embodiment is a two-component composition comprising Component I comprising

(A) at least one methylene malonate monomer having formula (I):

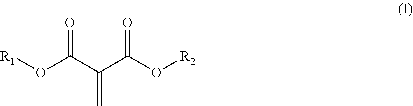

wherein, R₁ and R₂ are in each case independently selected from the group consisting of C1-C30-alkyl, C2-C30-alkenyl and C3-C30-cyclolalkyl

(B) at least one methylene malonate polymer having formula (II):

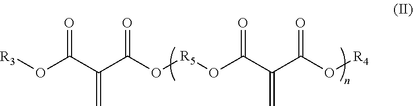

wherein, R₃ and R₄ are in each case independently selected from the group consisting of C1-C30-alkyl, C2-C30-alkenyl and C3-C30-cyclolalkyl

n is an integer from 2 to 8; and

R₅, if n=1 is, or if n>1 are in each case independently, selected from the group consisting of C1-C30-alkylene and C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Component II comprising at least one selected from N,N-Dimethylcyclohexylamine, 2,2′-Dimorpholinodiethylether, dimethylaminoethoxyethanol, bis(2-dimethylaminoethyl)ether, pentamethyldietylenetriamine, trimethylaminoethylethanolamine, tetramethyl-1,6-hexanediamine, 1,8-diazabicyclo-5,4,0-undecene-7,

wherein, the monomer (A) is in an amount of 5 to 35 wt. %, and the acidic stabilizer (C) is in an amount of 0.1 to 250 ppm, and the component II is in an amount of 0.5 to 1 wt. %, in each case based on the total weight of the monomer (A) and the polymer (B).

The 9^{th} embodiment is a two-component composition comprising Component I comprising

(A) at least one methylene malonate monomer having formula (I):

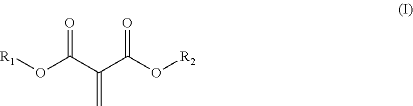

wherein, R₁ and R₂ are in each case independently selected from the group consisting of C1-C30-alkyl, C2-C30-alkenyl and C3-C30-cyclolalkyl

(B) at least one methylene malonate polymer having formula (II):

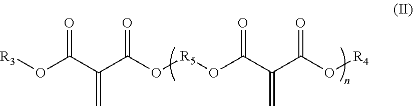

wherein, R₃ and R₄ are in each case independently selected from the group consisting of C1-C30-alkyl, C2-C30-alkenyl and C3-C30-cyclolalkyl

n is an integer from 2 to 8; and

R₅, if n=1 is, or if n>1 are in each case independently, selected from the group consisting of C1-C30-alkylene and C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Component II comprising at least one selected from 2,6-xylidine, 2-phenylethylamine, 4,4′-diaminodiphenylmethane, aniline, benzylamine, tris(dimethylaminomethyl)phenol, 2-dimethylaminomethylphenol,

wherein, the monomer (A) is in an amount of 10 to 35 wt. %, and the acidic stabilizer (C) is in an amount of 0.1 to 200 ppm, and the component II is in an amount of 0.05 to 5 wt. %, in each case based on the total weight of the monomer (A) and the polymer (B).

The 10^{th} embodiment is a two-component composition comprising Component I comprising

(A) at least one methylene malonate monomer having formula (I):

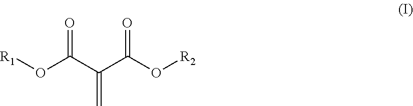

wherein, R₁ and R₂ are in each case independently selected from the group consisting of C1-C30-alkyl, C2-C30-alkenyl and C3-C30-cyclolalkyl

(B) at least one methylene malonate polymer having formula (II):

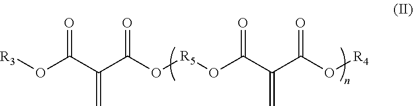

wherein, R₃ and R₄ are in each case independently selected from the group consisting of C1-C30-alkyl, C2-C30-alkenyl and C3-C30-cyclolalkyl

n is an integer from 2 to 8; and

R₅, if n=1 is, or if n>1 are in each case independently, selected from the group consisting of C1-C30-alkylene and C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Component II comprising at least one selected from diethanol-para-toluidine, diisopropanol-p-toluidine, N-(2-Hydroxyethyl)aniline, N,N-Di-(2-hydroxyethyl)aniline, N-ethyl-N-(2-hydroxyethyl)aniline, o-toluidine, p-ntrotoluene,

wherein, the monomer (A) is in an amount of 10 to 20 wt. %, and the acidic stabilizer (C) is in an amount of 0.1 to 150 ppm, and the component II is in an amount of 0.1 to 2 wt. %, in each case based on the total weight of the monomer (A) and the polymer (B).

The 11^{th} embodiment is a two-component composition comprising Component I comprising

(A) at least one methylene malonate monomer having formula (I):

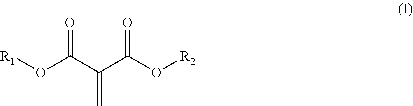

wherein, R₁ and R₂ are in each case independently selected from the group consisting of C1-C30-alkyl, C2-C30-alkenyl and C3-C30-cyclolalkyl

(B) at least one methylene malonate polymer having formula (II):

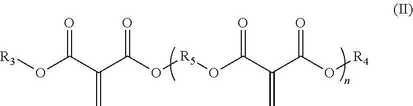

wherein, R₃ and R₄ are in each case independently selected from the group consisting of C1-C30-alkyl, C2-C30-alkenyl and C3-C30-cyclolalkyl

n is an integer from 2 to 8; and

R₅, if n=1 is, or if n>1 are in each case independently, selected from the group consisting of C1-C30-alkylene and C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Component II comprising at least one selected from sodium acetate; potassium acetate, zinc acetate, copper acetate, magnesium acetate, aluminium acetate, sodium chloracetate, potassium chloracetate, copper chloracetate, zinc chloracetate, magnesium chloracetate, aluminium chloracetate, ferric chloracetate, acid salts of sodium, potassium, lithium, copper, iron and cobalt, sodium oxide, potassium oxide, calcium oxide, zinc oxide, copper oxide, magnesium oxide, aluminium oxide, ferric and ferrous oxide, sodium hydroxide, potassium hydroxide, zinc hydroxide, copper hydroxide, magnesium hydroxide, aluminium hydroxide, calcium hydroxide, ferric and ferrous hydroxide, sodium silicate, potassium silicate, zinc silicate, copper silicate, magnesium silicate iron silicate and aluminium silicate,

wherein, the monomer (A) is in an amount of 10 to 20 wt. %, and the acidic stabilizer (C) is in an amount of 0.1 to 100 ppm, and the component II is in an amount of 0.05 to 0.1 wt. %, in each case based on the total weight of the monomer (A) and the polymer (B).

The 12^{th} embodiment is a two-component composition comprising Component I comprising

(A) at least one methylene malonate monomer having formula (I):

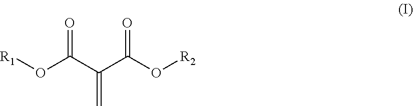

wherein, R₁ and R₂ are in each case independently selected from the group consisting of e C1-C30-alkyl, C2-C30-alkenyl, C3-C30-cycloalkyl, C6-C30-aryl, halo-C1-C30-alkyl;

(B) at least one methylene malonate polymer having formula (II):

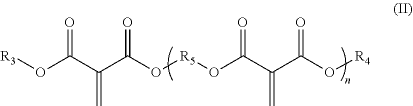

wherein, R₃ and R₄ are in each case independently selected from the group consisting of C1-C30-alkyl, C2-C30-alkenyl, C3-C30-cycloalkyl, C6-C30-aryl, halo-C1-C30-alkyl;

n is an integer from 3 to 6; and

R₅, if n=1 is, or if n>1 are in each case independently, selected from the group of C1-C30-alkylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Component II comprising at least one selected from calcium hydroxide, sodium silicate, sodium propionate, sodium benzoate, 2-dimethylaminomethylphenol (DMP10), N,N,N′,N′-Tetrakis(2-hydroxyethyl)ethylenediamine, lithium chloride, 2,2′-Dimorpholinodiethylether,

wherein, the monomer (A) is in an amount of 10 to 40 wt. %, and the acidic stabilizer (C) is in an amount of 0.1 to 100 ppm, and the component II is in an amount of 0.05 to 1 wt. %, in each case based on the total weight of the monomer (A) and the polymer (B).

The 13^{th} embodiment is a two-component composition comprising Component I comprising

(A) at least one methylene malonate monomer having formula (I):

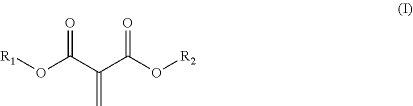

wherein, R₁ and R₂ are in each case independently selected from the group consisting of C1-C30-alkyl, C2-C30-alkenyl, C3-C30-cycloalkyl, C6-C30-aryl, halo-C1-C30-alkyl;

(B) at least one methylene malonate polymer having formula (II):

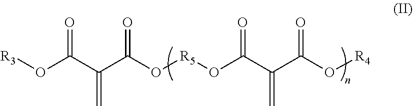

wherein, R₃ and R₄ are in each case independently selected from the group consisting of C1-C30-alkyl, C2-C30-alkenyl, C3-C30-cycloalkyl, C6-C30-aryl, halo-C1-C30-alkyl;

n is an integer from 3 to 6; and

R₅, if n=1 is, or if n>1 are in each case independently, selected from the group of C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Component II comprising at least one selected from triethylamine, tris(dimethylaminomethyl)phenol and 2-dimethylaminomethylphenol,

wherein, the monomer (A) is in an amount of 10 to 40 wt. %, and the acidic stabilizer (C) is in an amount of 0.1 to 100 ppm, and the component II is in an amount of 0.01 to 1 wt. %, in each case based on the total weight of the monomer (A) and the polymer (B).

The 14^{th} embodiment is a two-component composition comprising Component I comprising

(A) at least one methylene malonate monomer having formula (I):

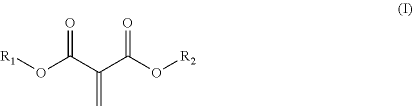

wherein, R₁ and R₂ are in each case independently selected from the group of C1-C30-alkyl;

(B) at least one methylene malonate polymer having formula (II):

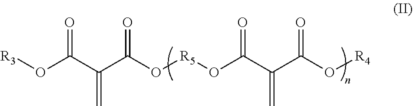

wherein, R₃ and R₄ are in each case independently selected from the group of C1-C30-alkyl;

n is an integer from 2 to 8; and

R₅, if n=1 is, or if n>1 are in each case independently, selected from the group of C6-C30-arylene and C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Component II comprising at least one selected from 2-ethylhexylamine, N-Octylamine, tridecylamine, 3,3′-dimethyl-4,4′-diaminodicyclohexylmethane, 4,4′-diaminodicyclohexylmethane, isophorone diamine, neopentanediamine (2,2-Dimethylpropane-1,3-diamine), octamethylenediamine, dibutylethanolamine, 4,4′-diaminodiphenylmethane, benzylamine, polyetheramine D 2000, polyetheramine D 230, polyetheramine D 400, polyetheramine T 403, polyetheramine T 5000, di-(2-ethylhexyl)amine, dibutylamine, dicyclohexylamine, ditridecylamine, 4,9-Dioxadodecane-1,12-diamine, di-(2-methoxyethyl)amine, dimethylethylamine, dimethylpropylamine, N,N-dimethylisopropylamine, N-Ethyldiisopropylamine, N,N-dimethylcyclohexylamine, trimethylamine, triethylamine, tripropylamine, tributylamine, tris-(2-ethylhexyl)amine, 2-(diisopropylamino)ethylamine, tetramethyl-1,6-hexanediamine, S-triazine, pentamethyldietylenetriamine, bis(2-dimethylaminoethyl) ether, N,N-Dimethylcyclohexylamine, bis(2-dimethylaminoethyl)ether, pentamethyldietylenetriamine, trimethylaminoethylethanolamine, tetramethyl-1,6-hexanediamine, tris(dimethylaminomethyl)phenol, 2-dimethylaminomethylphenol (DMP10), 3-(cyclohexylamino)propylamine, diethylenetriamine, dipropylene triamine, 3-(2-aminoethylamino)propylamine, N,N′-Bis-(3-Aminopropyl)ethylenediamine, 3-(diethylamino)propylamine, N,N-Bis-(3-aminopropyl)methylamine, butyldiethanolamine, triisopropanolamine, diethylethanolamine, methyldiethanolamine, methyldiisopropanolamine, N,N-dimethylethanolamine S, N,N-dimethylisopropanolamine, dimethylethanolamine, N,N,N′,N′-Tetrakis(2-hydroxyethyl)ethylenediamine, dimethylaminoethoxyethanol, diethanol-para-toluidine, diisopropanol-p-toluidine, 3-dimethylaminopropane-1-ol, 2,6-xylidine, 2-phenylethylamine, aniline, N-(2-hydroxyethyl)aniline, N,N-di-(2-hydroxyethyl)aniline, N-ethyl-N-(2-hydroxyethyl)aniline, o-toluidine, p-nitrotoluene,

wherein, the monomer (A) is in an amount of 10 to 40 wt. %, and the acidic stabilizer (C) is in an amount of 0.1 to 100 ppm, and the component II is in an amount of 0.01 to 1 wt. %, in each case based on the total weight of the monomer (A) and the polymer (B).

The 15^{th} embodiment is a mixture comprising the composition according to any one of embodiments 1-14 which further comprises one or more additives selected from the group consisting of plasticizers, thixotropic agents, adhesion promoters, antioxidants, light stabilizers, UV stabilizer, filler, cement, lime stone, surfactant, wetting agents, viscosity modifier, dispersants, air release agents, anti-sagging agents, anti-setting agents, defoaming agent, coloring agent, fiber, polymer powder, mesh, chip, hollow spheres and inert resins.

The 16^{th} embodiment is a mixture comprising the composition according to any one of embodiments 1-14, which further comprises one or more additives selected from the group consisting of plasticizers, thixotropic agents, surfactant, UV stabilizer, filler, cement, lime stone and defoaming agent.

The 17^{th} embodiment is a mixture comprising the composition according to any one of embodiments 1-14, which further comprises one or more additives selected from the group consisting of antioxidants, light stabilizers, UV stabilizers and fillers.

The 18^{th} embodiment is a mixture comprising the composition according to any one of embodiments 1-14, which further comprises one or more additives selected from the group consisting of light stabilizers, pigments, air release agents and defoaming agent.

The 19^{th} embodiment is a mixture comprising the composition according to any one of embodiments 1-14, which further comprises other additives selected from the group consisting of UV stabilizers pigments, air release agents and fillers.

The 20^{th} embodiment is a mixture comprising the composition according to any one of embodiments 1-14, which further comprises other additives selected from the group consisting of antioxidants, UV stabilizers, air release agents, defoaming agent and fillers.

### EXAMPLE

The present invention will now be described with reference to Examples and Comparative Examples, which are not intended to limit the present invention.

The following starting materials were used:

Diethyl malonate (DEM) and Dihexyl malonate (DHM) were purchased from Alfa Aesar. Paraformaldehyde, potassium acetate, copper (II) acetate, Novazym 435 as a catalyst were purchased from Acros Organics. Maleic acid, methane sulfonic acid, 1,5-pentanediol, 2-methylpropane-1,3-diol, 1,4-phenylenedimethanol were purchased from Alfa Aesar.

Analytical Methods

(1) NMR (Nuclear Magnetic Resonance)

Routine one-dimensional NMR spectroscopy was performed on either a 400 MHz Varian® spectrometer or a 400 MHz Bruker® spectrometer. The samples were dissolved in deuterated solvents. Chemical shifts were recorded on the ppm scale and were referenced to the appropriate solvent signals, such as 2.49 ppm for DMSO-d6, 1.93 ppm for CD3CN, 3.30 ppm for CD3OD, 5.32 ppm for CD2Cl2 and 7.26 ppm for CDCl3 for 1H spectra.

(2) GC-MS (Gas Chromatography Mass Spectrometer)

GC-MS was obtained with a Hewlett Packard 5970 mass spectrometer equipped Hewlett Packard 5890 Gas Chromatograph with. The ion source was maintained at 270° C.

(3) EI-MS (Electron Impact Mass Spectra)

EI-MS were obtained with a Hewlett Packard 5970 mass spectrometer equipped Hewlett Packard 5890 Gas Chromatograph with. The ion source was maintained at 270° C.

Measurement Methods

(1) Gel Time

Gel time means the time from the start of the composition until becoming the state of viscous, and it indicates the workability of the composition; particularly, long gel time (for example 20-30 min) is needed for roller coating, whereas short gel time (for example 0.5-5 min) is needed for spray coating.

(2) Dry Through Time

Dry through Time means the time from the start of mixing component I and component II to the solid state of the mixture.

(3) Hardness

Hardness (Shored D) is determined according to DIN53505.

(4) Chemicals Resistance

Chemicals (acids, bases or solvents) resistance is determined according to JSCE-E 549-2000 by the following procedure:
a. Add acid/base/solvents into a container and keep a constant temperature at 50° C. (for acid and base) or room temperature (for solvents).
b. Soaking the three samples in solution.
c. Take out the samples after a period of time.
d. After cleaning and drying, the surface quality such as blisters, wrinkles, of paint is evaluated essentially by visual inspection.

The difference of mass before and after immersion, expressed as a percentage of one hundred (%).

(5) Elongation

Elongation and Tensile Strength are each determined according to DIN 53504;

(6) Water Absorption

Water Absorption Rate after 24 hours (%) is determined according to ASTM D 570-2010 at 60° C.; and

(7) Abrasion Resistance

Abrasion Resistance is determined according to ASTM D 4060-07.

### Preparation Example

I. The Preparation of Monomer (A)

### Example 1: The Preparation of Diethyl Methylenemalonate (DEMM)

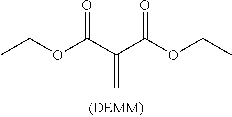

<1>. In a two-liter 3-neck round bottom flask (equipped with a condenser), 60 g of paraformaldehyde (2 mol), 10 g of potassium acetate and 10 g of copper (II) acetate were mixed in 80 ml of tetrahydrofuran (THF).

<2>. This mixture was stirred and heated at 65° C. for 40 min. From an additional funnel, 160 g (1 mol) of diethyl malonate (DEM) was then added dropwise to the reaction mixture.

<3>. At the end of the addition of DEM (about an hour), the reaction mixture was further stirred at 65° C. for 2 hours.

<4>. The reaction mixture was then cooled to room temperature and 10 g of sulfuric acid was added into the flask with stirring.

<5>. The precipitates were then removed by filtration and the filtrate was collected. 0.01 g of sulfuric acid (60 ppm) was added to the collected filtrate.

<6>. The filtrate was then distilled at reduced pressure. Diethyl Methylenemalonate was collected at 55-70° C. with about 1.5 mm Hg of vacuum as the crude monomer.

<7>. The crude monomer (with 60 ppm of sulfuric acid) was further fractionally distilled with stainless steel packed column under reduced vacuum. This gives 141 g (yield of 82%, purity of 98%) pure monomer.

<8>. The monomer was stabilized with 40 ppm of sulfuric acid.

1H-NMR (400 MHz, CDC13) 6.45 (s, 2H), 4.22 (q, 4H), 1.24 (t, 6H).

GC-MS (m/z): 173, 145, 127, 99, 55.

### Example 2: The Preparation of Dihexyl Methylene Malonate (DHMM)

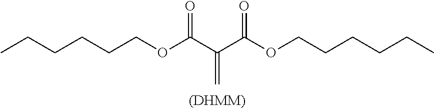

The preparation is carried out according to Example 1, except for using dihexyl malonate in step 2. This gives 227 g (yield of 80%, purity of 95%) pure monomer. The monomer was stabilized with 60 ppm of sulfuric acid.

GC-MS (m/z): 284.

### Example 3: The Preparation of Dicyclohexyl Methylene Malonate (DCHMM)

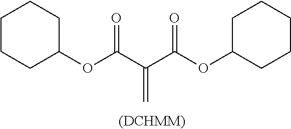

The preparation is carried out according to Example 1, except for using dicyclohexyl malonate in step 2. This gives 224 g (yield of 80%, purity of 95%) pure monomer. The monomer was stabilized with 60 ppm of sulfuric acid.

GC-MS (m/z): 280.

II. The Preparation of Polymer (B)

### Example 4: The Preparation of Polymer (B-1)

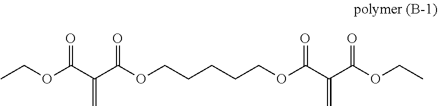 [SMILES: C=C(C(=O)OCC)C(=O)OCCCCCOC(=O)C(=C)C(=O)OCC]

In a round flask (equipped with a condenser), 0.5 g Novazym 435 (catalyst), 17.3 g DEMM (0.1 mol) and 4.2 g 1,5-pentanediol (0.04 mol) were added. The mixture was stirred and heated at 65° C. for 6 hours, while the alcohol generated was removed through evaporation. The reaction mixture was then cooled to room temperature and stabilized with 10 ppm maleic acid, methane sulfonic acid. The reaction mixture was filtered to remove the catalyst. The gives the desired product.

ESI-MS (m/z): 357.

### Example 5: The Preparation of Polymer (B-2)

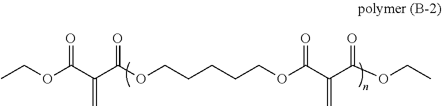

In a round flask (equipped with a condenser), 0.5 g Novazym 435 (catalyst), 17.3 g DEMM (0.1 mol) and 8.3 g 1,5-pentanediol (0.08 mol) were added. The mixture was stirred and heated at 65° C. for 6 hours, while the alcohol generated was removed through evaporation. The reaction mixture was then cooled to room temperature and stabilized with 10 ppm maleic acid, methane sulfonic acid. The reaction mixture was filtered to remove the catalyst. The gives the desired product, wherein n is an integer from 2 to 8.

ESI-MS (m/z): 541 (n=2), 725 (n=3), 909 (n=4), 1093 (n=5), 1277 (n=6), 1461 (n=7), 1645 (n=8).

### Example 6: The Preparation of Polymer (B-3)

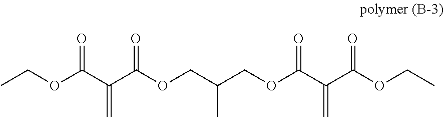 [SMILES: C=C(C(=O)OCC)C(=O)OCC(C)COC(=O)C(=C)C(=O)OCC]

In a round flask (equipped with a condenser), 0.5 g Novazym 435 (catalyst), 17.3 g DEMM (0.1 mol) and 3.6 g 2-methylpropane-1,3-diol (0.04 mol) were added. The mixture was stirred and heated at 65° C. for 6 hours, while the alcohol generated was removed through evaporation. The reaction mixture was then cooled to room temperature and stabilized with 10 ppm maleic acid, methane sulfonic acid. The reaction mixture was filtered to remove the catalyst. The gives the desired product.

ESI-MS (m/z): 343

### Example 7: The Preparation of Polymer (B-4)

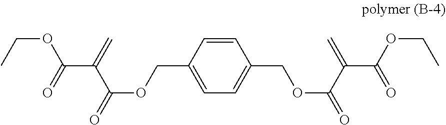 [SMILES: C=C(C(=O)OCC)C(=O)OCc1ccc(COC(=O)C(=C)C(=O)OCC)cc1]

In a round flask (equipped with a condenser), 0.5 g Novazym 435 (catalyst), 17.3 g DEMM (0.1 mol) and 5.52 g 1,4-phenylenedimethanol (0.04 mol) were added. The mixture was stirred and heated at 65° C. for 6 hours, while the alcohol generated was removed through evaporation. The reaction mixture was then cooled to room temperature and stabilized with 10 ppm maleic acid, methane sulfonic acid. The reaction mixture was filtered to remove the catalyst. The gives the desired product.

ESI-MS (m/z): 391

### Example 8: The Preparation of Polymer (B-5)

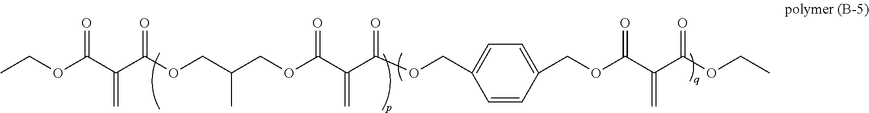

In a round flask (equipped with a condenser), 0.5 g Novazym 435 (catalyst), 17.3 g DEMM (0.1 mol) 3.6 g 2-methylpropane-1,3-diol (0.04 mol) and 5.52 g 1,4-phenylenedimethanol (0.04 mol) were added. The mixture was stirred and heated at 65° C. for 6 hours, while the alcohol generated was removed through evaporation. The reaction mixture was then cooled to room temperature and stabilized with 10 ppm maleic acid, methane sulfonic acid. The reaction mixture was filtered to remove the catalyst. The gives the desired product, wherein the sum of p and q is an integer from 2 to 8.

ESI-MS (m/z): 561 (p=1, q=1), 779 (p=1, q=2), 731 (p=2, q=1), 949 (p=2, q=2), 997 (p=1, q=3), 901 (p=3, q=1), 1215 (p=1, q=4), 1167 (p=2, q=3), 1119 (p=3, q=2), 1071 (p=4, q=1), 1433 (p=1, q=5), 1385 (p=2, q=4), 1337 (p=3, q=3), 1289 (p=4, q=2), 1241 (p=5, q=1)

III. The Preparation of Composition

### Example 9

According to the following general procedure, the compositions as per table 1 were applied on the concrete board by using gauge Mayer rod in ease case:

In the respective blending proportions shown in table 1, the monomer (A) and the polymer (B) were first placed in a glass vessel with a magnetic stir bar. While stirring, without heating, at 900 rpm, the acidic stabilizer (C) was added into the vessel. The mixture is continuously stirred for an additional 5 minutes. This gives a ready-made component I

Then, component II was added to component I and then was applied onto the surface of the concrete board, and then a 2.5 gauge Meyer rod was used to drag component II down on the concrete board resulting in a 0.2 mm film 1. Then the formulation was cast on concrete slab using a 14 gauge Meyer rod resulting in a 1 mm film 2.

TABLE 1
The components of the two-component compositions in inventive
composition and comparative composition

| | | | | | | Compara- |
|---|---|---|---|---|---|---|
| | | | Inventive | | | tive com- |
| Composition | | | composition | | | position |
| No. | | | 1 | 2 | 3 | 4 |
| Compo- | (A): Monomer | DHMM | — | — | — | 50 |
| nent I | (% by weight) | DCHMM | — | — | 40 | — |
| | | DEMM | — | 10 | — | 5 |
| | (B): Polymer | Polymer (B-1) | 44 | 40 | 27 | 20 |
| | (% by weight) | Polymer (B-2) | 56 | 50 | 33 | 25 |
| | (C): maleic | MSA | 30 | 32 | 25 | 32.5 |
| | acid (ppm) | H₂SO₄ | 10 | — | 11 | — |
| | | TFA | — | 9 | — | 11.5 |

| | | | | | |
|---|---|---|---|---|---|
| Compo- | DMP10 (% by weight) | — | 0.5 | — | 0.5 |
| nent II | Lithium chloride | 0.025 | — | — | — |
| | (% by weight) | | | | |
| | Calcium hydroxide | — | — | 10 | — |
| | (% by weight) | | | | |

### Test Example

Example 9: Gel time and dry through time of the inventive composition and the comparative composition were tested. The results are shown in the following table 2.

TABLE 2

| | | Inventive | | | Comparative |
|---|---|---|---|---|---|
| Composition | | composition | | | composition |
| No. | | 1 | 2 | 3 | 4 |
| Gel time (minutes) | -20° C.; 10% RH | — | 35 | — | 25 |
| | 25° C.; 50% RH | 30 | 43 | 25 | 32 |
| | 35° C.; 90% RH | — | 32 | — | 22 |
| Dry through Time | -20° C.; 10% RH | — | 50 | — | 29 |
| (minutes) | 25° C.; 50% RH | 105 | 60 | 120 | 39 |
| Layer thickness: 1 mm | 35° C.; 90% RH | — | 45 | — | 30 |
| Dry through Time | -20° C.; 10% RH | — | 60 | — | 32 |
| (minutes) | | | | | |
| Layer thickness: 0.2 mm | 25° C.; 50% RH | 120 | 75 | 15 | 44 |
| | 35° C.; 90% RH | — | 65 | — | 40 |

Gel time is defined as the time from mixing Component I and II to the mixture becoming too viscous and loose the workability.

Dry through time is defined as the time from brushing the mixture of Component I and II into a layer with certain thickness to said layer becoming completely dry.

It should be noted that it is acceptable that the flooring coating material has a gel time of from 30 min to 2 h and a dry through time of less than 8 h. From the above, it shows that the samples of Example exhibit excellent workability at low temperature (even below 0° C.) and high humidity levels (even up to 90% RH), and fast and controlled curing.

### Example 10: Test of Chemical Resistance and Mechanical Properties

The test samples were prepared by mixing the monomer (A), the polymer (B) and the acidic stabilizer (C) in amounts according to table 2 at 25° C. and under atmospheric pressure, forming component I; the component I were combined with the component II in amounts according to table 2 under the same temperature and pressure. The sample from Example B differs from the samples from Example A in that the compositions in this text were not in practice applied onto a substrate but were cured as per se. However, the compositions of Examples A and B have the same structure/composition.

### Example 11

Base/acid/solvent resistance was tested and the results are shown in table 3 below.

TABLE 3
The data of the Base/acid/solvent resistance

| | | Inventive composition | | | | | | Comparative composition | |
|---|---|---|---|---|---|---|---|---|---|
| Composition | | 1 | | 2 | | 3 | | 4 | |
| No. | | Change rate | Hardness | Change rate | Hardness | Change rate | Hardness | Change rate | Hardness |
| Solvent | Days | of mass (%) | (Shore D) | of mass (%) | (Shore D) | of mass (%) | (Shore D) | of mass (%) | (Shore D) |
| HCl | 0 | 1.5 | 67.7 | 0.57 | 79.7 | 1.1 | 72.8 | 0.91 | 49.7 |
| (0.1M) | 30 | | 75 | | 73.6 | | 76 | | 45.6 |
| At 50° C. | | | | | | | | | |
| NaOH | 0 | 0.4 | 67.9 | 0.36 | 72.7 | 0.82 | 74.6 | 1.23 | 46.7 |
| (5%) | 30 | | 72.4 | | 74.3 | | 68.6 | | 44.3 |
| At 50° C. | | | | | | | | | |
| H₂O₂ | 0 | — | — | 1.03 | 83.3 | — | — | 1.5 | 43.3 |
| at 25° C. | 30 | | — | | 85 | | — | | 48.0 |
| Methanol | 0 | — | — | 5.18 | 81.5 | — | — | 5.99 | 41.7 |
| at 25° C. | 30 | | — | | 83.5 | | — | | 47.5 |
| Xylene | 0 | — | — | 7.32 | 79.9 | — | — | 100 | 46.9 |
| at 25° C. | 30 | | — | | 80.5 | | — | | dissolved |

Note:
The change rate of mass (%) = (m₃₀-m₀)/m₀, wherein m₃₀ and m₀ are the mass value of the samples on day 0 and day 30, respectively.

From the above, it shows that the inventive composition has a smaller change in the mass between before and after immersion in the specified acid/base/solvent, compared with that of the comparative composition, showing the inventive composition has a better chemical resistance compared with that of comparative composition. In addition, it shows that the mass of the comparative composition was decreased significantly over time when immersed in xylene. It is assumed that the decrease in mass is due to the sample being dissolved in xylene, which also proves that the sample of the comparative composition has an inferior chemical resistance.

On the other hand, it should be noted that the inventive composition has a higher hardness (shore D), which value is not or little affected after immersion in the above specified base/acid/solvent, compared with that of the comparative example, showing the inventive composition exhibit excellent chemical resistance.

### Example 12

The test samples were obtained by the same process of Example B. Water absorption was tested and the results are shown in table 4 below.

TABLE 4
The data of the water absorption

| Composition | Inventive composition | Comparative Example |
|---|---|---|
| No. | 2 | 4 |
| Water Absorption Rate | 0.12% | 0.14% |
| after 24 hours (%) | | |

From the above, it shows that the inventive composition has a lower water absorption rate after 24 hours than that of comparative example, showing that the sample of the invention has excellent water-resistance compared to that of comparative example.

### Example 13

The test samples were obtained by the same process of Example B. Mechanical properties were tested and the results are shown in table 5 below.

TABLE 5
The data of the mechanical properties

| | | Inventive | Comparative |
|---|---|---|---|
| Composition | | composition | Example |
| No. | | 2 | 4 |
| Elongation Rate (%) | | 10 | 13 |
| Tensile Strength (MPa) | | 16 | 5 |
| Abrasion | After 400 cycles′ milling | 25 ± 3 mg | 35 ± 3 mg |
| (weight loss) | After 1000 cycles′ milling | 50 ± 5 mg | 60 ± 5 mg |

It is advantage that the inventive composition has a lower elongation rate, a higher tensile strength and abrasion resistance (after 400-1000 cycles' milling) compared with that of comparative example. The above results indicate that the sample of the invention has excellent mechanical properties, thus suitable for use as a flooring coating material.

The structures, materials, compositions, and methods described herein are intended to be representative examples of the invention, and it will be understood that the scope of the invention is not limited by the scope of the examples. Those skilled in the art will recognize that the invention may be practiced with variations on the disclosed structures, materials, compositions, and methods, and such variations are regarded as within the ambit of the invention. Thus, it is intended that the present invention cover such modifications and variations as come within the scope of the appended claims and their equivalents.

1.-22. (canceled)

23. A two-component composition comprising Component I comprising
(A) at least one methylene malonate monomer having formula (I): 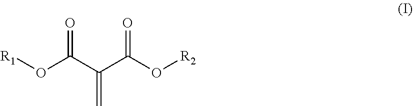
wherein, R₁ and R₂ are in each case independently selected from the group consisting of C1-C30-alkyl, C2-C30-alkenyl, C3-C30-cyclolalkyl, C2-C30-heterocyclyl, C2-C30-heterocyclyl-(C1-C30-alkyl), C6-C30-aryl, C6-C30-aryl-C1-C30-alkyl, C2-C30-heteroaryl, C2-C30-heteroaryl-C1-C30-alkyl, and C1-C30-alkoxy-C1-C30-alkyl, halo-C1-C30-alkyl, halo-C3-C30-cyclolalkyl, each of which radicals is optionally substituted, the heteroatom being selected from N, O and S;
(B) at least one methylene malonate polymer having formula (II): 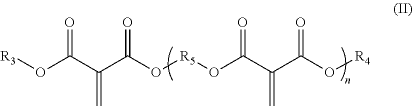
wherein, R₃ and R₄ are, in each case independently selected from the group consisting of C1-C30-alkyl, C2-C30-alkenyl, C3-C30-cyclolalkyl, C2-C30-heterocyclyl, C2-C30-heterocyclyl-C1-C30-alkyl, C6-C30-aryl, C6-C30-aryl-(C1-C30-alkyl), C2-C30-heteroaryl, C2-C30-heteroaryl-C1-C30-alkyl, C1-C30-alkoxy-C1-C30-alkyl, halo-C1-C30-alkyl, and halo-C3-C30-cyclolalkyl, each of which radicals is optionally substituted, the heteroatom being selected from N, O and S;
n is an integer from 1 to 20;
R₅, if n=1 is, or if n>1 are in each case independently, selected from the group consisting of C1-C30-alkylene, C2-C30-alkenylene, C2-C30-alkynylene, C6-C30-arylene, C3-C30-cyclolalkylene, C3-C30-cyclolalkenylene, C3-C30-cyclolalkynylene, C2-C30-heterocyclylene, and C2-C30-heteroarylene, each of which radicals is optionally substituted, the heteroatom being selected from N, O and S, wherein R₅ is optionally interrupted by a radical selected from N, O and S; and
(C) at least one acidic stabilizer;
and Component II comprising at least one alkali accelerator,
wherein, the monomer (A) is in an amount of from 0 to 40 wt. %, in each case based on the total weight of the monomer (A) and the polymer (B);
the acidic stabilizer (C) is in an amount of from 0.1 to 500 ppm; and
the component II is in an amount of from 0.01 to 10 wt %, in each case based on the total weight of the components (I) and (II).

24. The two-component composition according to claim 23, wherein the two-component composition includes two independent packages of component I and component II that may be mixed on the spot for applications of the composition.

25. The two-component composition according to claim 23, wherein R₁ and R₂ are in each case independently selected from the group consisting of C1-C10-alkyl, C2-C10-alkenyl, C3-C10-cyclolalkyl, C2-C10-hetercyclyl, C2-C10-hetercyclyl-C1-C10-alkyl, C3-C18-aryl, C3-C18-aryl-C1-C10-alkyl, C2-C10-heteroaryl, C2-C10-heteroaryl-C1-C10-alkyl, and C1-C10-alkoxy-C1-C10-alkyl, halo-C1-C10-alkyl, and halo-C3-C10-cyclolalkyl, each of which radicals is optionally substituted by at least one radical selected from the group consisting of halogen, hydroxyl, nitro, cyano, C1-C10-alkyl, C2-C10-alkenyl, C2-C10-alkynyl, C1-C10-alkoxy, C3-C10-cyclolalkyl, C2-C10-hetercyclyl, C2-C10-hetercyclyl-C1-C10-alkyl, halo-C1-C10-alkyl, halo-C3-C10-cyclolalkyl, C3-C18-aryl, C3-C18-aryl-C1-C10-alkyl, C2-C10-heteroaryl, C3-C10-cyclolalkenyl, and C3-C10-cyclolalkynyl, the heteroatom being selected from N, O and S;
R₃ and R₄ are in each case independently selected from the group consisting of C1-C10-alkyl, C2-C10-alkenyl, C3-C10-cyclolalkyl, C2-C10-hetercyclyl, C2-C10-hetercyclyl-C1-C10-alkyl, C3-C18-aryl, C3-C18-aryl-C1-C10-alkyl, C2-C10-heteroaryl, C2-C10-heteroaryl-C1-C10-alkyl, and C1-C10-alkoxy-C1-C10-alkyl, halo-C1-C10-alkyl, and halo-C3-C10-cyclolalkyl, each of which radicals is optionally substituted by at least one radical selected from the group consisting of halogen, hydroxyl, nitro, cyano, C1-C10-alkyl, C2-C10-alkenyl, C2-C10-alkynyl, C1-C10-alkoxy, C3-C10-cyclolalkyl, C2-C10-hetercyclyl, C2-C10-hetercyclyl-C1-C10-alkyl, halo-C1-C10-alkyl, halo-C3-C10-cyclolalkyl, C3-C18-aryl, C3-C18-aryl-C1-C10-alkyl, C2-C10-heteroaryl, C3-C10-cyclolalkenyl, and C3-C10-cyclolalkynyl, the heteroatom being selected from N, O and S;
n is an integer from 1 to 15;
R₅, if n=1 is, or if n>1 are in each case independently, selected from the group consisting of C1-C10-alkylene, C2-C10-alkenylene, C2-C10-alkynylene, C3-C18-arylene, C3-C10-cyclolalkylene, C3-C10-cyclolalkenylene, C3-C10-cyclolalkynylene, C2-C10-hetercyclylene, and C2-C10-heteroarylene, each of which radicals is optionally substituted by at least one radical selected from the group consisting of halogen, hydroxyl, nitro, cyano, C1-C10-alkyl, C2-C10-alkenyl, C2-C10-alkynyl, C1-C10-alkoxy, C3-C10-cyclolalkyl, C2-C10-hetercyclyl, C2-C10-hetercyclyl-C1-C10-alkyl, halo-C1-C10-alkyl, halo-C3-C10-cyclolalkyl, C3-C18-aryl, C3-C18-aryl-C1-C10-alkyl, C2-C10-heteroaryl, C3-C10-cyclolalkenyl, and C3-C10-cyclolalkynyl, the heteroatom being selected from N, O and S, wherein R₅ is optionally interrupted by a radical selected from N, O and S.

26. The two-component composition according to claim 23, wherein R₁ and R₂ are in each case independently selected from the group consisting of C1-C6-alkyl, C2-C6-alkenyl, C3-C6-cyclolalkyl, C3-C6-hetercyclyl, C3-C6-hetercyclyl-C1-C6-alkyl, C6-C8-aryl, C6-C8-aryl-C1-C6-alkyl, C3-C6-heteroaryl, C3-C6-heteroaryl-C1-C6-alkyl, C1-C6-alkoxy-C1-C6-alkyl, halo-C1-C10-alkyl, and halo-C3-C10-cyclolalkyl, each of which radicals is optionally substituted by at least one radical selected from the group consisting of halogen, hydroxyl, nitro, cyano, C1-C6-alkyl, C2-C6-alkenyl, C2-C6-alkynyl, C1-C6-alkoxy, C3-C6-cyclolalkyl, C3-C6-hetercyclyl, C3-C6-hetercyclyl-C1-C6-alkyl, halo-C1-C6-alkyl, halo-C3-C6-cyclolalkyl, C6-C8-aryl, C6-C8-aryl-C1-C6-alkyl, C3-C6-heteroaryl, C3-C6-cyclolalkenyl, and C3-C6-cyclolalkynyl, the heteroatom being selected from N, O and S;
R₃ and R₄ are in each case independently selected from the group consisting of C1-C6-alkyl, C2-C6-alkenyl, C3-C6-cyclolalkyl, C3-C6-hetercyclyl, C3-C6-hetercyclyl-C1-C6-alkyl, C6-C8-aryl, C6-C8-aryl-C1-C6-alkyl, C3-C6-heteroaryl, C3-C6-heteroaryl-C1-C6-alkyl, C1-C6-alkoxy-C1-C6-alkyl, halo-C1-C10-alkyl, and halo-C3-C10-cyclolalkyl, each of which radicals is optionally substituted by at least one radical selected from the group consisting of halogen, hydroxyl, nitro, cyano, C1-C6-alkyl, C2-C6-alkenyl, C2-C6-alkynyl, C1-C6-alkoxy, C3-C6-cyclolalkyl, C3-C6-hetercyclyl, C3-C6-hetercyclyl-C1-C6-alkyl, halo-C1-C6-alkyl, halo-C3-C6-cyclolalkyl, C6-C8-aryl, C6-C8-aryl-C1-C6-alkyl, C3-C6-heteroaryl, C3-C6-cyclolalkenyl, and C3-C6-cyclolalkynyl, the heteroatom being selected from N, O and S;
n is an integer from 1 to 10;
R₅, if n=1 is, or if n>1 are in each case independently, selected from the group consisting of C1-C6-alkylene, C2-C6-alkenylene, C2-C6-alkynylene, C6-C8-arylene, C3-C6-cyclolalkylene, C3-C6-cyclolalkenylene, C3-C10-cyclolalkynylene, C3-C6-hetercyclylene, and C3-C6-heteroarylene, each of which radicals is optionally substituted by at least one radical selected from the group consisting of halogen, hydroxyl, nitro, cyano, C1-C6-alkyl, C2-C6-alkenyl, C2-C6-alkynyl, C1-C6-alkoxy, C3-C6-cyclolalkyl, C3-C6-hetercyclyl, C3-C6-hetercyclyl-C1-C6-alkyl, halo-C1-C6-alkyl, halo-C3-C6-cyclolalkyl, C6-C8-aryl, C6-C8-aryl-C1-C6-alkyl, C3-C6-heteroaryl, C3-C6-cyclolalkenyl, and C3-C6-cyclolalkynyl, the heteroatom being selected from N, O and S, wherein R₅ is optionally interrupted by a radical selected from N, O and S.

27. The two-component composition according to claim 23, wherein R₁ and R₂ are in each case independently selected from the group consisting of C1-C6-alkyl;
R₃ and R₄ are in each case independently selected from the group consisting of C1-C6-alkyl;
n is an integer from 1 to 8; and
R₅, if n=1 is, or if n>1 are in each case independently, selected from the group consisting of C1-C6-alkylene and C6-C8-arylene, each of which radicals is optionally substituted by at least one C1-C6-alkyl.

28. The two-component composition according to claim 23, wherein the acidic stabilizer (C) is selected from trifluoromethane sulfonic acid, chlorodifluoro acid, maleic acid, methane sulfonic acid, difluoroacetic acid, trichloroacetic acid, phosphoric acid, dichloroacetic acid, phenol and a mixture thereof.

29. The two-component composition according to claim 23, wherein the alkali accelerator is at least one selected from a base, a base precursor, or a base enhancer.

30. The two-component composition according to claim 29, wherein the alkali accelerator is at least one selected from metallic oxide, metallic hydroxide, amine, guanidine, amide, piperidine, piperazine, morpholine, pyridine, halides, salts of metal, ammonium, amine, wherein the anions in said salts is at least one selected from halogens, acetates, chloracetates, benzoates, aliphatic acids, alkene carboxylic acids, sulfurs, carbonates, silicates, diketones, monocarboxylic acids, polymers containing carboxylic acids.

31. The two-component composition according to claim 30, wherein the alkali accelerator is at least one selected from dimethylethylamine, dimethylpropylamine, 2-ethylhexylamine, di-(2-ethylhexyl)amine, dibutylamine, dicyclohexylamine, ditridecylamine mixture of isomers, N,N-dimethylisopropylamine, N-ethyldiisopropylamine, N,N-dimethylcyclohexylamine, N-Octylamine, tributylamine, tridecylamine mixture of isomers, tripropylamine, tris-(2-ethylhexyl)amine, triethylamine, trimethylamine, 2-(diisopropylamino)ethylamine, 3-(cyclohexylamino)propylamine, 3-(diethylamino)propylamine, 3,3′-dimethyl-4,4′-diaminodicyclohexylmethane, 4,4′-diaminodicyclohexylmethane, isophorone diamine, tetramethyl-1,6-hexanediamine, S-triazine, neopentanediamine (2,2-Dimethylpropane-1,3-diamine), octamethylenediamine, diethylenetriamine, dipropylene triamine, pentamethyldietylenetriamine, N,N-Bis-(3-aminopropyl)methylamine, N3-Amine 3-(2-Aminoethylamino)propylamine, N4-Amine N,N′-Bis-(3-Aminopropyl)ethylenediamine, 4,9-Dioxadodecane-1,12-diamine, di-(2-methoxyethyl)amine, bis(2-dimethylaminoethyl) ether, polyetheramine D 2000, polyetheramine D 230, polyetheramine D 400, polyetheramine T 403, polyetheramine T 5000, N,N-Dimethylcyclohexylamine, N-methylmorpholine, 2,2′-Dimorpholinodiethylether, dimethylaminoethoxyethanol, bis(2-dimethylaminoethyl)ether, pentamethyldietylenetriamine, trimethylaminoethylethanolamine, tetramethyl-1,6-hexanediamine, 1,8-diazabicyclo-5,4,0-undecene-7, 2,6-xylidine, 2-phenylethylamine, 4,4′-diaminodiphenylmethane, aniline, benzylamine, tris(dimethylaminomethyl)phenol, 2-dimethylaminomethylphenol (DMP10), diethanol-para-toluidine, diisopropanol-p-toluidine, N-(2-hydroxyethyl)aniline, N,N-di-(2-hydroxyethyl)aniline, N-ethyl-N-(2-hydroxyethyl)aniline, o-toluidine, p-nitrotoluene, 3-dimethylaminopropane-1-ol, butyldiethanolamine, triisopropanolamine, dibutylethanolamine, diethylethanolamine, methyldiethanolamine, methyldiisopropanolamine, N,N-dimethylethanolamine S, N,N-dimethylisopropanolamine, dimethylethanolamine, 4-(2-hydroxyethyl)morpholine, N,N,N′,N′-Tetrakis(2-hydroxyethyl)ethylenediamine, sodium acetate, potassium acetate, zinc acetate, copper acetate, magnesium acetate, aluminium acetate, sodium chloracetate, potassium chloracetate, copper chloracetate, zinc chloracetate, magnesium chloracetate, aluminium chloracetate, ferric chloracetate, acid salts of sodium, potassium, lithium, copper, iron and cobalt, sodium oxide, potassium oxide, calcium oxide, zinc oxide, copper oxide, magnesium oxide, aluminium oxide, ferric and ferrous oxide, sodium hydroxide, potassium hydroxide, zinc hydroxide, copper hydroxide, magnesium hydroxide, aluminium hydroxide, calcium hydroxide, ferric and ferrous hydroxide, sodium silicate, potassium silicate, zinc silicate, copper silicate, magnesium silicate iron silicate, aluminium silicate, lithium chloride and tetramethyl guanidine.

32. The composition according to claim 23, wherein the composition has an elongation rate (%), a tensile strength (MPa) and a weight loss (mg) after 400 cycle's milling concerning the abrasion resistance, and they satisfy the following relationship:
1.05<(2 ER/[%]+TS/[Mpa])/AR [mg]<2.25.
wherein, ER is an abbreviation of the elongation rate, which is determined according to DIN 53504, TS is an abbreviation of the tensile strength, which is determined according to DIN 53504, and AR is an abbreviation of the weight loss (mg) after 400 cycle's milling concerning abrasion resistance, which is determined according to ASTM D 4060-07.

33. A mixture comprising the two-component composition according to claim 23.

34. The mixture according to claim 33, wherein the mixture is substantial absence of any solvent.

35. A process for preparing the composition according to claim 23, comprising steps of:
(1) mixing the monomer (A), the polymer (B) and the acidic stabilizer (C) to obtain component I; and
(2) preparing the component II.

36. A floor coating which comprises the two-component composition according to claim 23.

37. The floor coating according to claim 36, wherein the two-component composition is applied on a substrate selected from the group consisting of concrete, wood, resin layer and stone.

38. The floor coating according to claim 37, wherein the resin layer is selected from cement-based resin layer, epoxy-based resin layer, polyurethane-based resin layer, acrylate-based resin layer, polyethylene layer, polypropylene layer, polyvinylchloride, rubber layer, bitumen layer and polymer-modified bitumen layer.

39. The floor coating according to claim 36, wherein the two-component composition or the mixture is applied on wet substrates.

40. The floor coating according to claim 36, wherein component I and component II are mixed before applying onto substrates.

41. The floor coating according to claim 36, wherein component II is applied onto substrates first and component I is applied onto substrates in next step.

42. The floor coating according to claim 36, wherein the temperature for the use is from −30° C. to 60° C. and the relative humidity for the use is from 1% to 99%.
